(19) United States
(12) Patent Application Publication
(10) Pub. No.: US 2022/0236530 A1
(43) Pub. Date: Jul. 28, 2022

(54) OPTICAL PHOTOGRAPHING LENS ASSEMBLY, IMAGE CAPTURING UNIT AND ELECTRONIC DEVICE

(71) Applicant: LARGAN PRECISION CO., LTD., Taichung City (TW)

(72) Inventors: Yu Jui LIN, Taichung City (TW); Jin Sen WANG, (TW); Tzu-Chieh KUO, Taichung City (TW)

(73) Assignee: LARGAN PRECISION CO., LTD., Taichung City (TW)

(21) Appl. No.: 17/198,089

(22) Filed: Mar. 10, 2021

(30) Foreign Application Priority Data
Jan. 27, 2021 (TW) 110102954

(51) Int. Cl. G02B 13/00; G02B 9/60; G02B 13/02; G02B 13/06; G02B 27/00

(52) U.S. Cl. CPC G02B 13/0045; G02B 9/60; G02B 27/0025; G02B 13/06; G02B 13/02

(57) ABSTRACT

An optical photographing lens assembly includes five lens elements which are, in order from an object side to an image side along an optical path: a first lens element, a second lens element, a third lens element, a fourth lens element and a fifth lens element. Each of the five lens elements has an object-side surface facing toward the object side and an image-side surface facing toward the image side. The first lens element has negative refractive power, and the object-side surface of the first lens element is concave in a paraxial region thereof. The five lens elements include at least one freeform lens element, and at least one of the object-side surface and the image-side surface of the at least one freeform lens element is a freeform surface.

### RELATED APPLICATIONS

This application claims priority to Taiwan Application 110102954, filed on Jan. 27, 2021, which is incorporated by reference herein in its entirety.

### BACKGROUND

### Technical Field

The present disclosure relates to an optical photographing lens assembly, an image capturing unit and an electronic device, more particularly to an optical photographing lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an optical photographing lens assembly includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

The first lens element has negative refractive power, and the object-side surface of the first lens element is concave in a paraxial region thereof. The five lens elements include at least one freeform lens element, and at least one of the object-side surface and the image-side surface of the at least one freeform lens element is a freeform surface.

When a paraxial curvature radius of the object-side surface of the first lens element in a maximum image height direction is R1, and a focal length of the optical photographing lens assembly in the maximum image height direction is f, the following condition is satisfied:

−4.5<R1/f<−0.30.

According to another aspect of the present disclosure, an optical photographing lens assembly includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

The object-side surface of the first lens element is concave in a paraxial region thereof. The five lens elements include at least one freeform lens element, and at least one of the object-side surface and the image-side surface of the at least one freeform lens element is a freeform surface.

When a focal length of the optical photographing lens assembly in a maximum image height direction is f, and a composite focal length of the fourth lens element and the fifth lens element in the maximum image height direction is f45, the following condition is satisfied:

1.9<f45/f.

According to another aspect of the present disclosure, an optical photographing lens assembly includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

The first lens element has negative refractive power. The second lens element has positive refractive power. The image-side surface of the fifth lens element is concave in a paraxial region thereof. The five lens elements include at least one freeform lens element, and at least one of the object-side surface and the image-side surface of the at least one freeform lens element is a freeform surface.

When a central thickness of the first lens element is CT1, and a central thickness of the fourth lens element is CT4, the following condition is satisfied:

0.38<CT1/CT4<1.9.

According to another aspect of the present disclosure, an image capturing unit includes one of the aforementioned optical photographing lens assemblies and an image sensor, wherein the image sensor is disposed on an image surface of the optical photographing lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a cross-sectional view of an image capturing unit corresponding to a diagonal direction of a photosensitive area of an image sensor according to the 1st embodiment of the present disclosure;

FIG. 2 shows spherical aberration curves, astigmatic field curves and a distortion curve of the image capturing unit according to the 1st embodiment;

FIG. 3 is a cross-sectional view of an image capturing unit corresponding to a diagonal direction of a photosensitive area of an image sensor according to the 2nd embodiment of the present disclosure;

FIG. 4 shows spherical aberration curves, astigmatic field curves and a distortion curve of the image capturing unit according to the 2nd embodiment;

FIG. 5 is a cross-sectional view of an image capturing unit corresponding to a diagonal direction of a photosensitive area of an image sensor according to the 3rd embodiment of the present disclosure;

FIG. 6 shows spherical aberration curves, astigmatic field curves and a distortion curve of the image capturing unit according to the 3rd embodiment;

FIG. 7 is a cross-sectional view of an image capturing unit corresponding to a diagonal direction of a photosensitive area of an image sensor according to the 4th embodiment of the present disclosure;

FIG. 8 shows spherical aberration curves, astigmatic field curves and a distortion curve of the image capturing unit according to the 4th embodiment;

FIG. 9 is a cross-sectional view of an image capturing unit corresponding to a diagonal direction of a photosensitive area of an image sensor according to the 5th embodiment of the present disclosure;

FIG. 10 shows spherical aberration curves, astigmatic field curves and a distortion curve of the image capturing unit according to the 5th embodiment;

FIG. 11 is a cross-sectional view of an image capturing unit corresponding to a diagonal direction of a photosensitive area of an image sensor according to the 6th embodiment of the present disclosure;

FIG. 12 shows spherical aberration curves, astigmatic field curves and a distortion curve of the image capturing unit according to the 6th embodiment;

FIG. 13 is a cross-sectional view of an image capturing unit corresponding to a diagonal direction of a photosensitive area of an image sensor according to the 7th embodiment of the present disclosure;

FIG. 14 shows spherical aberration curves, astigmatic field curves and a distortion curve of the image capturing unit according to the 7th embodiment;

FIG. 15 is a cross-sectional view of an image capturing unit corresponding to a diagonal direction of a photosensitive area of an image sensor according to the 8th embodiment of the present disclosure;

FIG. 16 shows spherical aberration curves, astigmatic field curves and a distortion curve of the image capturing unit according to the 8th embodiment;

FIG. 17 is a perspective view of an image capturing unit according to the 9th embodiment of the present disclosure;

FIG. 18 is one perspective view of an electronic device according to the 10th embodiment of the present disclosure;

FIG. 19 is another perspective view of the electronic device in FIG. 18;

FIG. 20 is a block diagram of the electronic device in FIG. 18;

FIG. 21 is one perspective view of an electronic device according to the 11th embodiment of the present disclosure;

FIG. 22 is one perspective view of an electronic device according to the 12th embodiment of the present disclosure;

FIG. 23 shows a superposition of ImgHX, ImgHY, ImgHD and surface shapes of the image-side surface of the fifth lens element corresponding to the diagonal direction, a lengthwise direction and a widthwise direction of the photosensitive area of the image sensor according to the 1st embodiment of the present disclosure;

FIG. 24 shows an enlarged view of the region AA in FIG. 23;

FIG. 25 shows a schematic view of Ymin, CTF, SAG, a cross-sectional view of the fifth lens element corresponding to the widthwise direction of the photosensitive area of the image sensor and a front view of the image-side surface of the fifth lens element according to the 1st embodiment of the present disclosure;

FIG. 26 is a data graph of SAG of all positions at a distance of Ymin from the optical axis on the image-side surface of the fifth lens element according to the 1st embodiment of the present disclosure;

FIG. 27 is a schematic view of a configuration of the fifth lens element and the image sensor according to the 1st embodiment of the present disclosure;

FIG. 28 shows a schematic view of Y11, Y52, and critical points of the first and fifth lens elements according to the 1st embodiment of the present disclosure;

FIG. 29 shows a schematic view of an imaging area of the image sensor and ImgHX, ImgHY and ImgHD according to the 1st embodiment of the present disclosure;

FIG. 30 shows a schematic view of a configuration of a light-folding element in an optical photographing lens assembly according to one embodiment of the present disclosure;

FIG. 31 shows a schematic view of another configuration of a light-folding element in an optical photographing lens assembly according to one embodiment of the present disclosure; and

FIG. 32 shows a schematic view of a configuration of two light-folding elements in an optical photographing lens assembly according to one embodiment of the present disclosure.

### DETAILED DESCRIPTION

An optical photographing lens assembly includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

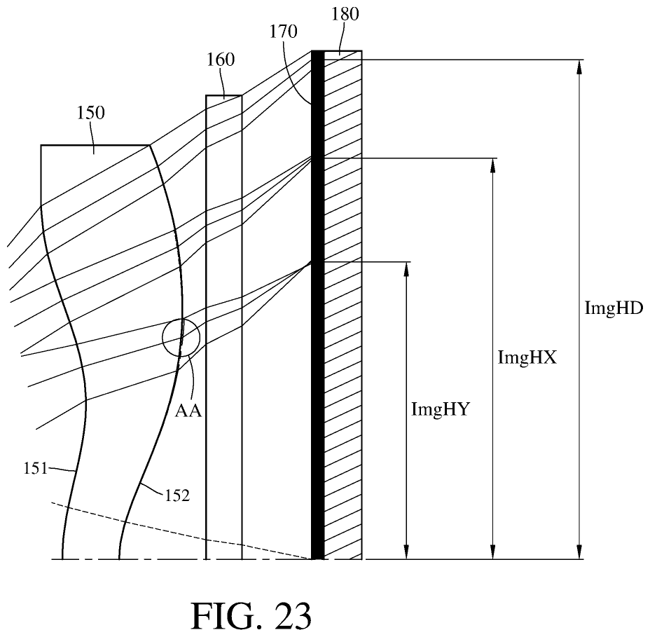

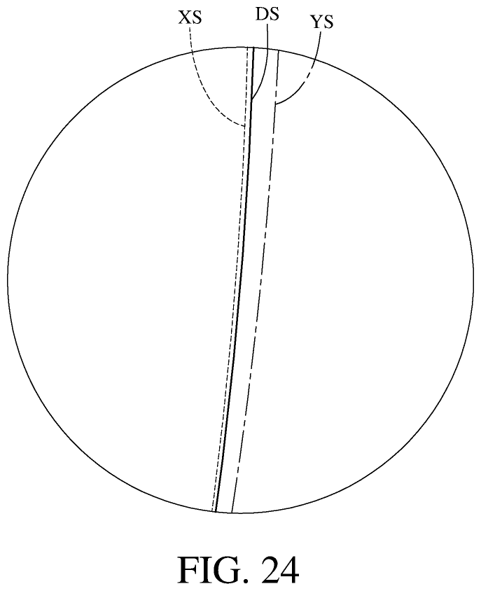

According to the present disclosure, the five lens elements of the optical photographing lens assembly include at least one freeform lens element, and at least one of the object-side surface and the image-side surface of the at least one freeform lens element is a freeform surface. Therefore, the freeform lens element is favorable for correcting aberrations such as distortion; furthermore, capturing low-distortion images is favorable for the optical photographing lens assembly to be applicable to various applications, especially for wide field-of-view designs. In the present disclosure, a freeform surface (FFS) is a non-axisymmetric aspheric surface. Moreover, at least one of the first lens element and the fifth lens element can be a freeform lens element. Therefore, it is favorable for reducing the influence of non-axisymmetric lens elements on the assembling process, thereby increasing assembling yield rate. Please refer to FIG. 23 and FIG. 24. FIG. 23 shows a superposition of ImgHX, ImgHY, ImgHD and surface shapes of the image-side surface of the fifth lens element corresponding to a diagonal direction, a lengthwise direction and a widthwise direction of the photosensitive area of the image sensor according to the 1st embodiment of the present disclosure, and FIG. 24 shows an enlarged view of the region AA in FIG. 23. FIG. 24 shows the difference of the surface shapes DS, XS, YS of the image-side surface 152 of the fifth lens element 150 corresponding to the diagonal direction, the lengthwise direction and the widthwise direction of the photosensitive area of the image sensor 180 at the same distance from an optical axis, which can be exemplary of the non-axisymmetric aspheric surface.

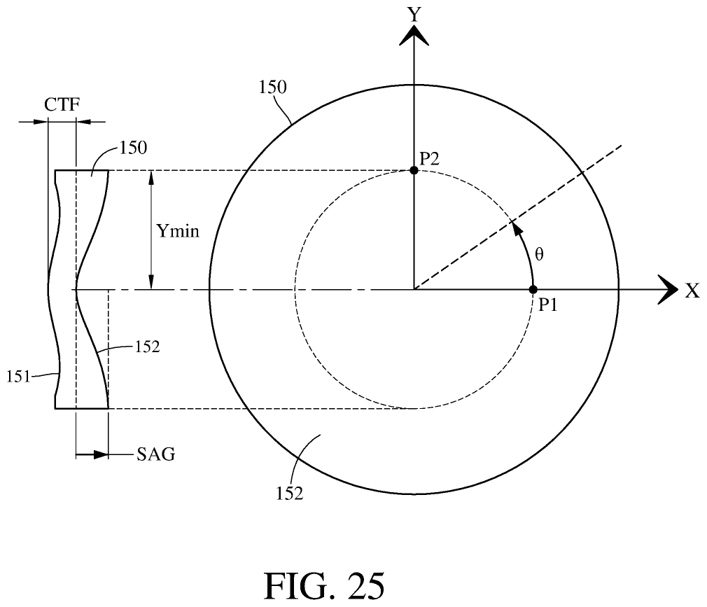

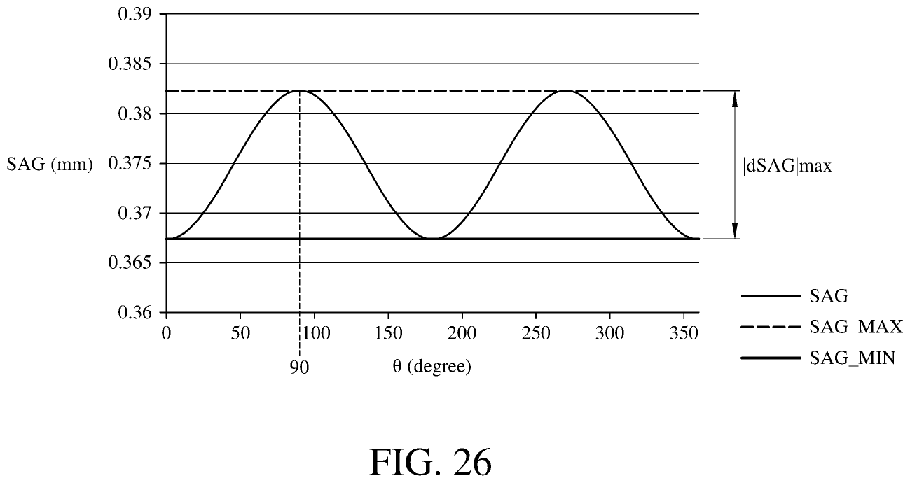

According to the present disclosure, a minimum value among distances between the optical axis and a boundary of an optically effective area of one lens surface is Ymin, a displacement in parallel with the optical axis from an intersection point between the lens surface and the optical axis to a position at a distance of Ymin from the optical axis on the lens surface is SAG, a maximum value among all the displacements SAG is SAG_MAX, and a minimum value among all the displacements SAG is SAG_MIN. When an absolute difference between SAG_MAX and SAG_MIN is |dSAG|max, at least one freeform surface of at least one freeform lens element of the optical photographing lens assembly can satisfy the following condition: 0.45 um<|dSAG|max. Therefore, it is favorable for increasing the shape variation of the freeform surface so as to further correct aberrations. Moreover, the following condition can also be satisfied: 0.60 um<|dSAG|max. Moreover, the following condition can also be satisfied: 0.75 um<|dSAG|max. Please refer to FIG. 25 and FIG. 26. FIG. 25 shows a schematic view of Ymin, SAG, a cross-sectional view of the fifth lens element corresponding to the widthwise direction of the photosensitive area of the image sensor and a front view of the image-side surface of the fifth lens element according to the 1st embodiment of the present disclosure, and FIG. 26 is a data graph of SAG of all positions at a distance of Ymin from the optical axis on the image-side surface of the fifth lens element according to the 1st embodiment of the present disclosure. When the displacement from the intersection point between one freeform surface and the optical axis to a point at a distance of Ymin from the optical axis on the same surface is facing towards the image side of the optical photographing lens assembly, the value of displacement is positive; when the displacement from the intersection point between the freeform surface and the optical axis to a point at a distance of Ymin from the optical axis on the same surface is facing towards the object side of the optical photographing lens assembly, the value of displacement is negative. In FIG. 25, there is a minimum distance Ymin between the optical axis and the boundary of the optically effective area of the image-side surface 152 of the fifth lens element 150 in the direction corresponding to the widthwise direction Y of the photosensitive area of the image sensor. FIG. 26 shows the values of displacements SAG of all positions at a distance of Ymin from the optical axis on the image-side surface 152 of the fifth lens element 150, where the horizontal axis represents the angle θ between the positive X-axis and a dotted line as shown in FIG. 26, the angle θ is 0 degree as the dotted line is at the positive X-axis, and the angle θ increases as the dotted line rotates counterclockwise about the Z-axis; the vertical axis represents the displacements SAG corresponding to various angles 6. As seen in FIG. 25 from the front view of the image-side surface 152 of the fifth lens element 150, there can be one SAG value at any position in a distance of Ymin from the optical axis on the image-side surface 152 of the fifth lens element 150. For example, when the angle θ is 0 degree, there is a corresponding SAG value equal to 0.367 mm at the position P1 at a distance of Ymin from the optical axis on the image-side surface 152 of the fifth lens element 150; when the angle θ is 90 degrees, there is a corresponding SAG value equal to 0.382 mm at the position P2 at a distance of Ymin from the optical axis on the image-side surface 152 of the fifth lens element 150. As seen in FIG. 26, there can be a maximum value SAG_MAX and a minimum value SAG_MIN among all displacements SAG, and the absolute difference between SAG_MAX and SAG_MIN is |dSAG|max.

When the absolute difference between SAG_MAX and SAG_MIN is |dSAG|max, and a central thickness of one freeform lens element is CTF, at least one freeform surface of at least one freeform lens element of the optical photographing lens assembly can satisfy the following condition: 1.00E-3<|dSAG|max/CTF. Therefore, it is favorable for increasing the shape variation of the freeform surface so as to further correct aberrations. Please refer to FIG. 25, which shows a schematic view of CTF according to the 1st embodiment of the present disclosure.

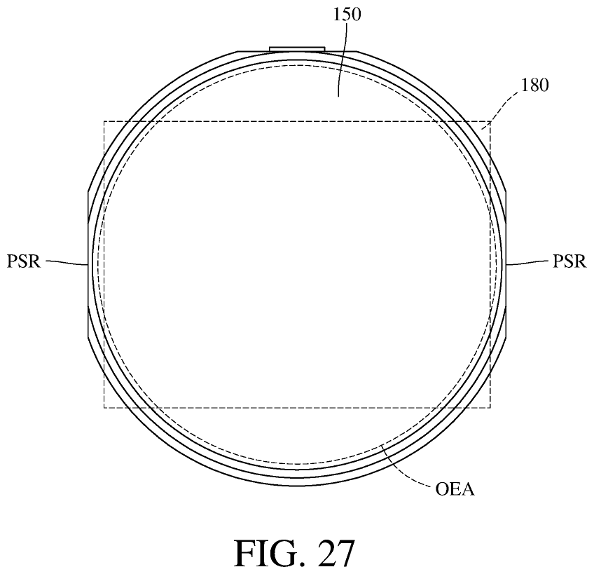

According to the present disclosure, one lens surface of the freeform lens element can have an optically non-effective area at the periphery of freeform lens element and does not overlap the optically effective area. The freeform lens element can have at least one positioning structure at the optically non-effective area. Therefore, it is favorable for the maximum image height direction to correspond to the image sensor during the assembling process. Moreover, the freeform lens element can also have at least two positioning structures at the optically non-effective area. Moreover, the positioning structure can include a flat cut line. Therefore, it is favorable for increasing the recognizability of the positioning structure. Please refer to FIG. 27, which is a schematic view of a configuration of the image sensor 180 and the fifth lens element 150 according to the 1st embodiment of the present disclosure. In the 1st embodiment, the fifth lens element 150 is a freeform lens element and has two positioning structures PSR at the region thereof (optically non-effective area) outside its optically effective area OEA, and each of the positioning structures PSR includes a flat cut line. The fifth lens element having positioning structures in FIG. 27 according to the 1st embodiment is only exemplary. Other freeform lens elements in various embodiments of the present disclosure can also have similar positioning structures.

The first lens element can have negative refractive power. Therefore, it is favorable for increasing the field of view. The object-side surface of the first lens element can be concave in a paraxial region thereof. Therefore, it is favorable for increasing the field of view and reducing the size at the object side of the optical photographing lens assembly. The object-side surface of the first lens element can have at least one critical point in an off-axis region thereof and in a maximum image height direction. Therefore, it is favorable for adjusting the incident direction of light rays on the first lens element so as to improve image quality of light rays at wide field of view on an image surface.

The second lens element can have positive refractive power. Therefore, it is favorable for reducing the total track length of the optical photographing lens assembly. The object-side surface of the second lens element can be convex in a paraxial region thereof. Therefore, it is favorable for collaborating with the first lens element so as to enlarge the field of view. The image-side surface of the second lens element can be convex in a paraxial region thereof. Therefore, it is favorable for adjusting the travelling direction of light so as to balance the size distribution between the object side and the image side of the optical photographing lens assembly.

The image-side surface of the third lens element can be concave in a paraxial region thereof. Therefore, it is favorable for correcting aberrations such as astigmatism.

The fourth lens element can have positive refractive power. Therefore, it is favorable for balancing the refractive power distribution of the optical photographing lens assembly so as to reduce sensitivity of the optical photographing lens assembly. The image-side surface of the fourth lens element can be convex in a paraxial region thereof. Therefore, it is favorable for collaborating with the fifth lens element so as to correct off-axis aberrations.

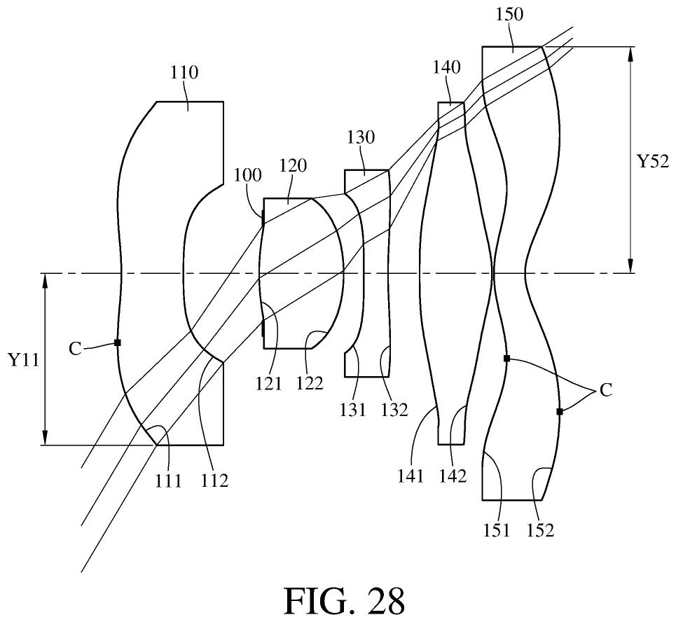

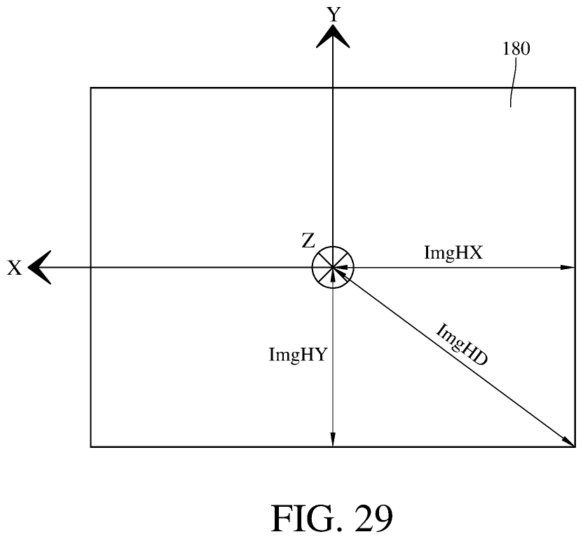

The fifth lens element can have negative refractive power. Therefore, it is favorable for balancing the refractive power at the image side of the optical photographing lens assembly so as to correct aberrations such as spherical aberration. The object-side surface of the fifth lens element can be convex in a paraxial region thereof. Therefore, it is favorable for collaborating with the fourth lens element so as to correct aberrations. The object-side surface of the fifth lens element can have at least one critical point in an off-axis region thereof and in the maximum image height direction. Therefore, it is favorable for adjusting the angle of incident light rays on the fifth lens element so as to reduce stray light. The image-side surface of the fifth lens element can be concave in a paraxial region thereof. Therefore, it is favorable for adjusting the back focal length of the optical photographing lens assembly. The image-side surface of the fifth lens element can have at least one critical point in an off-axis region thereof and in the maximum image height direction. Therefore, it is favorable for adjusting the angle of incident light rays on the image surface so as to improve the response efficiency of the image sensor. Please refer to FIG. 28, which shows a schematic view of the critical points C of the first lens element 110 and the fifth lens element 150 in the maximum image height direction according to the 1st embodiment of the present disclosure. The critical points of the object-side surface of the first lens element, the object-side surface of the fifth lens element and the image-side surface of the fifth lens element in the maximum image height direction are only exemplary. The object-side surface and the image-side surface of each lens element in various embodiments of the present disclosure can also have one or more critical points in an off-axis region thereof and in the maximum image height direction. Said maximum image height direction is a direction corresponding to a maximum distance between the optical axis and an imaging position on an image sensor. For example, please refer to FIG. 23 and FIG. 29, where FIG. 23 shows a superposition of ImgHX, ImgHY and ImgHD corresponding to the diagonal direction, the lengthwise direction and the widthwise direction of the photosensitive area of the image sensor according to the 1st embodiment of the present disclosure, and FIG. 29 shows a schematic view of an imaging area of the image sensor and ImgHX, ImgHY and ImgHD according to the 1st embodiment of the present disclosure. In FIG. 29, a direction of light travelling along the optical axis into the image sensor 180 is the positive Z-axis direction, a direction corresponding to the lengthwise direction of the photosensitive area of the image sensor 180 is the X-axis direction, a direction corresponding to the widthwise direction of the photosensitive area of the image sensor 180 is the Y-axis direction, ImgHX is a maximum distance between the optical axis and the imaging position of the optical photographing lens assembly corresponding to the lengthwise direction (i.e., the X-axis direction) of the photosensitive area of the image sensor 180, ImgHY is a maximum distance between the optical axis and the imaging position of the optical photographing lens assembly corresponding to the widthwise direction (i.e., the Y-axis direction) of the photosensitive area of the image sensor 180, and ImgHD is a maximum distance between the optical axis and the imaging position of the optical photographing lens assembly corresponding to a diagonal direction of the photosensitive area of the image sensor 180. In FIG. 23 and FIG. 29, ImgHD is a maximum image height of the optical photographing lens assembly (which can be half of a diagonal length of the effective photosensitive area of the image sensor), so the maximum image height direction can refer to the diagonal direction of the photosensitive area of the image sensor 180.

When a paraxial curvature radius of the object-side surface of the first lens element in the maximum image height direction is R1, and a focal length of the optical photographing lens assembly in the maximum image height direction is f, the following condition can be satisfied: −4.5<R1/f<−0.30. Therefore, it is favorable for adjusting the surface shape and refractive power of the first lens element so as to enlarge the field of view and reduce the size of the optical photographing lens assembly. Moreover, the following condition can also be satisfied: −3.5<R1/f<−0.70. Moreover, the following condition can also be satisfied: −2.5<R1/f<−1.0.

When the focal length of the optical photographing lens assembly in the maximum image height direction is f, and a composite focal length of the fourth lens element and the fifth lens element in the maximum image height direction is f45, the following condition can be satisfied: 1.9<f45/f. Therefore, it is favorable for the collaboration between the refractive power of the fourth lens element and that of the fifth lens element so as to correct aberrations. Moreover, the following condition can also be satisfied: 2.1<f45/f<5.0. Moreover, the following condition can also be satisfied: 2.3<f45/f<3.6.

When a central thickness of the first lens element is CT1, and a central thickness of the fourth lens element is CT4, the following condition can be satisfied: 0.38<CT1/CT4<1.9. Therefore, it is favorable for adjusting the distribution of lens elements so as to obtain a wide-field-of-view configuration. Moreover, the following condition can also be satisfied: 0.44<CT1/CT4<1.6. Moreover, the following condition can also be satisfied: 0.50<CT1/CT4<1.3. Moreover, the following condition can also be satisfied: 0.56<CT1/CT4<1.0.

When an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the i-th lens element is Vi, a refractive index of the first lens element is N1, a refractive index of the second lens element is N2, a refractive index of the third lens element is N3, a refractive index of the fourth lens element is N4, a refractive index of the fifth lens element is N5, a refractive index of the i-th lens element is Ni, and a minimum value of Vi/Ni is (Vi/Ni)min, the following condition can be satisfied: 7.50<(Vi/Ni)min<11.0, wherein i=1, 2, 3, 4 or 5. Therefore, it is favorable for adjusting the material distribution of lens elements so as to correct aberrations and reduce the size of the optical photographing lens assembly.

When the central thickness of the first lens element is CT1, a central thickness of the second lens element is CT2, a central thickness of the third lens element is CT3, the central thickness of the fourth lens element is CT4, and a central thickness of the fifth lens element is CT5, the following condition can be satisfied: 2.0<(CT2+CT3+CT4+CT5)/CT1<6.5. Therefore, it is favorable for adjusting the distribution of lens elements so as to obtain a wide-field-of-view configuration. Moreover, the following condition can also be satisfied: 3.0<(CT2+CT3+CT4+CT5)/CT1<5.5.

When a maximum distance between the optical axis and a boundary of an optically effective area of the object-side surface of the first lens element is Y11, and a maximum distance between the optical axis and a boundary of an optically effective area of the image-side surface of the fifth lens element is Y52, the following condition can be satisfied: 1.0<Y52/Y11<1.7. Therefore, it is favorable for utilizing the space in the optical photographing lens assembly so as to reduce the object-side pupil diameter of the optical photographing lens assembly in a wide-field-of-view configuration. Please refer to FIG. 28, which shows a schematic view of Y11 and Y52 according to the 1st embodiment of the present disclosure. In the embodiments of the present disclosure, the maximum distance between the optical axis and the boundary of the optically effective area of one lens surface is the distance between the optical axis and the boundary of the optically effective area of one lens surface in the diagonal direction of the photosensitive area of the image sensor, but the present disclosure is not limited thereto.

When the central thickness of the first lens element is CT1, the central thickness of the second lens element is CT2, the central thickness of the third lens element is CT3, the central thickness of the fourth lens element is CT4, and the central thickness of the fifth lens element is CT5, the following condition can be satisfied: 2.9<(CT1+CT2+CT4)/(CT3+CT5)<6.0. Therefore, it is favorable for adjusting the arrangement of lens elements so as to reduce the size of the optical photographing lens assembly. Moreover, the following condition can also be satisfied: 3.3<(CT1+CT2+CT4)/(CT3+CT5)<5.0.

When the Abbe number of the third lens element is V3, and the Abbe number of the fifth lens element is V5, the following condition can be satisfied: 20.0<V3+V5<60.0. Therefore, it is favorable for adjusting the material distribution so as to correct aberrations such as chromatic aberration. Moreover, the following condition can also be satisfied: 24.0<V3+V5<50.0. Moreover, the following condition can also be satisfied: 28.0<V3+V5<40.0.

When a paraxial curvature radius of the image-side surface of the fourth lens element in the maximum image height direction is R8, and the focal length of the optical photographing lens assembly in the maximum image height direction is f, the following condition can be satisfied: −2.3<R8/f<−0.43. Therefore, it is favorable for adjusting the surface shape and refractive power of the fourth lens element so as to reduce the size of the optical photographing lens assembly and correct aberrations. Moreover, the following condition can also be satisfied: −1.5<R8/f<−0.51.

When the focal length of the optical photographing lens assembly in the maximum image height direction is f, and a composite focal length of the first lens element, the second lens element and the third lens element in the maximum image height direction is f123, the following condition can be satisfied: 1.0<f123/f<2.4. Therefore, it is favorable for the first through third lens elements to collaborate with one another so as to reduce the object-side size of the optical photographing lens assembly. Moreover, the following condition can also be satisfied: 1.5<f123/f<2.0.

When an axial distance between the object-side surface of the first lens element and the image surface is TL, and the focal length of the optical photographing lens assembly in the maximum image height direction is f, the following condition can be satisfied: 2.2<TL/f<4.0. Therefore, it is favorable for obtaining a balance between the total track length and the field of view of the optical photographing lens assembly. Moreover, the following condition can also be satisfied: 2.5<TL/f<3.6.

When an f-number of the optical photographing lens assembly is Fno, the following condition can be satisfied: 1.6<Fno<2.6. Therefore, it is favorable for balancing the illuminance and depth of field.

When the Abbe number of the second lens element is V2, the Abbe number of the third lens element is V3, and the Abbe number of the fourth lens element is V4, the following condition can be satisfied: 4.0<(V2+V4)/V3<8.5. Therefore, it is favorable for the collaboration of materials of the second through fourth lens elements so as to correct aberrations such as chromatic aberration. Moreover, the following condition can also be satisfied: 5.0<(V2+V4)/V3<8.0. Moreover, the following condition can also be satisfied: 6.0<(V2+V4)/V3<7.5.

When an axial distance between the second lens element and the third lens element is T23, and an axial distance between the third lens element and the fourth lens element is T34, the following condition can be satisfied: 1.0<T34/T23<6.5. Therefore, it is favorable for adjusting the distribution of the lens elements so as to balance the size distribution between the object side and image side of the optical photographing lens assembly. Moreover, the following condition can also be satisfied: 1.3<T34/T23<5.0.

When the axial distance between the object-side surface of the first lens element and the image surface is TL, and a maximum image height of the optical photographing lens assembly is ImgH, the following condition can be satisfied: 1.0<TL/ImgH<2.8. Therefore, it is favorable for obtaining a balance between reducing the total track length and enlarging the image surface, and also favorable for adjusting the field of view. Moreover, the following condition can also be satisfied: 1.2<TL/ImgH<2.2.

When half of a maximum field of view of the optical photographing lens assembly is HFOV, the following condition can be satisfied: 47.5 degrees<HFOV<70.0 degrees. Therefore, it is favorable for obtaining a wide angle configuration and preventing aberrations, such as distortion, caused by an overly large field of view. Moreover, the following condition can also be satisfied: 55.0 degrees<HFOV<65.0 degrees.

When the paraxial curvature radius of the object-side surface of the first lens element in the maximum image height direction is R1, and a focal length of the first lens element in the maximum image height direction is f1, the following condition can be satisfied: 0.10<R1/f1<1.9. Therefore, it is favorable for adjusting the surface shape and refractive power of the first lens element so as to enlarge the field of view and reduce the size of the optical photographing lens assembly. Moreover, the following condition can also be satisfied: 0.35<R1/f1<1.4.

When a focal length of the fourth lens element in a maximum image height direction is f4, and the central thickness of the fourth lens element is CT4, the following condition can be satisfied: 1.9<f4/CT4<5.0. Therefore, it is favorable for adjusting the surface shape and refractive power of the fourth lens element so as to reduce the size of the optical photographing lens assembly. Moreover, the following condition can also be satisfied: 2.1<f4/CT4<3.5.

When a paraxial curvature radius of the object-side surface of the fifth lens element in the maximum image height direction is R9, and a paraxial curvature radius of the image-side surface of the fifth lens element in the maximum image height direction is R10, the following condition can be satisfied: 1.6<(R9+R10)/(R9−R10)<5.0. Therefore, it is favorable for adjusting the surface shape of the fifth lens element so as to correct off-axis aberrations. Moreover, the following condition can also be satisfied: 2.2<(R9+R10)/(R9−R10)<4.5.

When the focal length of the optical photographing lens assembly in the maximum image height direction is f, and a focal length of the fifth lens element in the maximum image height direction is f5, the following condition can be satisfied: −1.0<f/f5<−0.20. Therefore, it is favorable for adjusting the refractive power of the fifth lens element so as to correct aberrations.

According to the present disclosure, the aforementioned features and conditions can be utilized in numerous combinations so as to achieve corresponding effects.

According to the present disclosure, the lens elements of the optical photographing lens assembly can be made of either glass or plastic material. When the lens elements are made of glass material, the refractive power distribution of the optical photographing lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the optical photographing lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof. In addition, unless otherwise stated, the aspheric surface in the embodiments refers to an axisymmetric aspheric surface, and the freeform surface in the embodiments refers to a non-axisymmetric aspheric surface.

According to the present disclosure, when the features and parameters, such as the field of view, focal length and curvature radius, with axisymmetric properties or non-axisymmetric properties of the optical photographing lens assembly are not specifically defined, these features and parameters can be determined in the maximum image height direction (which can be the diagonal direction of the effective photosensitive area of the image sensor).

According to the present disclosure, one or more of the lens elements' material may optionally include an additive which alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power or focus of a lens element is not defined, it indicates that the region of refractive power or focus of the lens element is in the paraxial region thereof.

According to the present disclosure, a critical point is a non-axial point of the lens surface where its tangent is perpendicular to the optical axis.

According to the present disclosure, the image surface of the optical photographing lens assembly, based on the corresponding image sensor, can be flat or curved, especially a curved surface being concave facing towards the object side of the optical photographing lens assembly.

According to the present disclosure, an image correction unit, such as a field flattener, can be optionally disposed between the lens element closest to the image side of the optical photographing lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

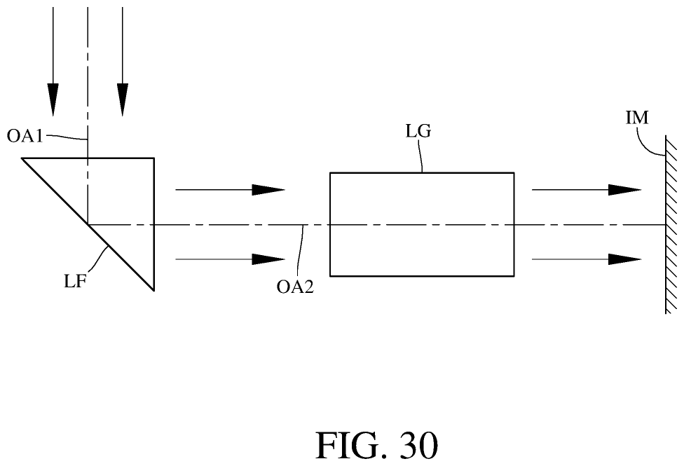

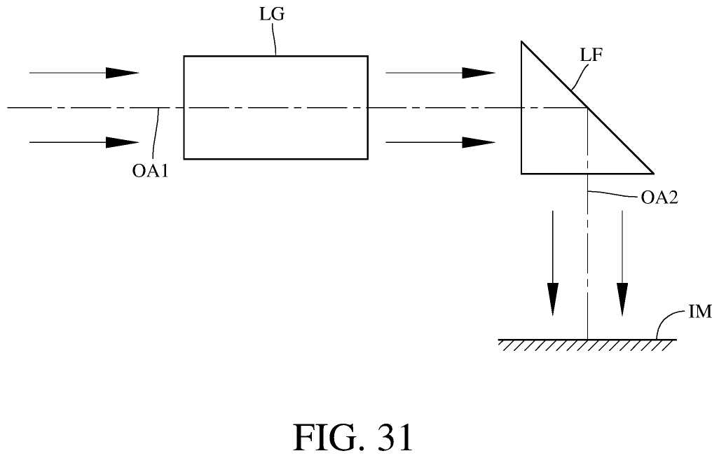

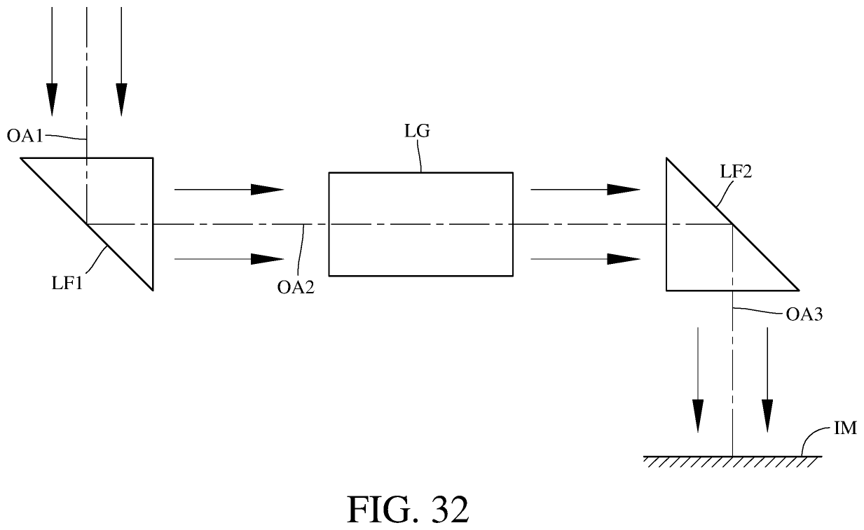

According to the present disclosure, at least one light-folding element, such as a prism or a mirror, can be optionally disposed between an imaged object and the image surface on the imaging optical path, such that the optical photographing lens assembly can be more flexible in space arrangement, and therefore the dimensions of an electronic device is not restricted by the total track length of the optical photographing lens assembly. Specifically, please refer to FIG. 30 and FIG. 31. FIG. 30 shows a schematic view of a configuration of a light-folding element in an optical photographing lens assembly according to one embodiment of the present disclosure, and FIG. 31 shows a schematic view of another configuration of a light-folding element in an optical photographing lens assembly according to one embodiment of the present disclosure. In FIG. 30 and FIG. 31, the optical photographing lens assembly can have, in order from an imaged object (not shown in the figures) to an image surface IM along an optical path, a first optical axis OA1, a light-folding element LF and a second optical axis OA2. The light-folding element LF can be disposed between the imaged object and a lens group LG of the optical photographing lens assembly as shown in FIG. 30 or disposed between a lens group LG of the optical photographing lens assembly and the image surface IM as shown in FIG. 31. Furthermore, please refer to FIG. 32, which shows a schematic view of a configuration of two light-folding elements in an optical photographing lens assembly according to one embodiment of the present disclosure. In FIG. 32, the optical photographing lens assembly can have, in order from an imaged object (not shown in the figure) to an image surface IM along an optical path, a first optical axis OA1, a first light-folding element LF1, a second optical axis OA2, a second light-folding element LF2 and a third optical axis OA3. The first light-folding element LF1 is disposed between the imaged object and a lens group LG of the optical photographing lens assembly, the second light-folding element LF2 is disposed between the lens group LG of the optical photographing lens assembly and the image surface IM. The optical photographing lens assembly can be optionally provided with three or more light-folding elements, and the present disclosure is not limited to the type, amount and position of the light-folding elements of the embodiments disclosed in the aforementioned figures.

According to the present disclosure, the optical photographing lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the optical photographing lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the optical photographing lens assembly and thereby provides a wider field of view for the same.

According to the present disclosure, the optical photographing lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the above description of the present disclosure, the following specific embodiments are provided for further explanation.

### 1st Embodiment

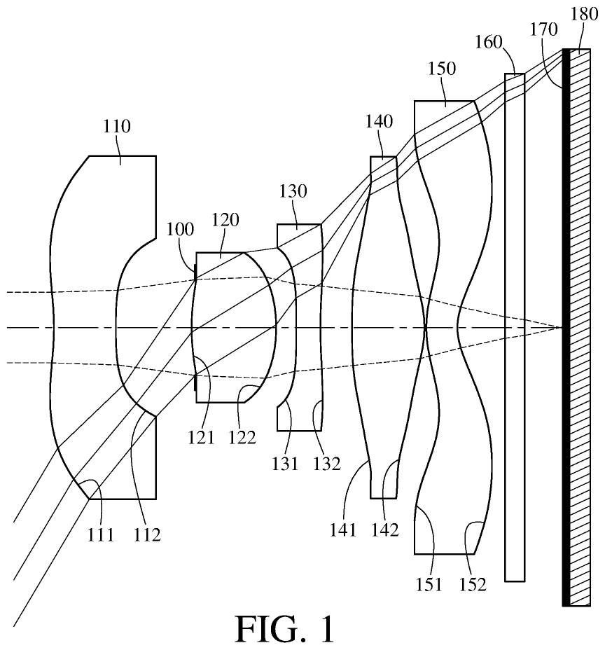

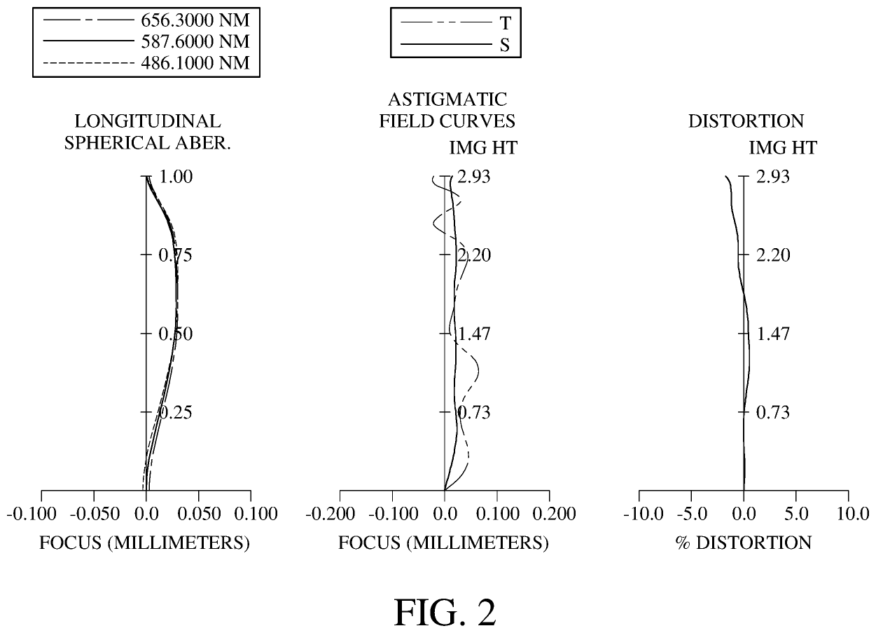

FIG. 1 is a cross-sectional view of an image capturing unit corresponding to a diagonal direction of a photosensitive area of an image sensor according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit includes the optical photographing lens assembly (its reference numeral is omitted) of the present disclosure and an image sensor 180. The optical photographing lens assembly includes, in order from an object side to an image side along an optical path, a first lens element 110, an aperture stop 100, a second lens element 120, a third lens element 130, a fourth lens element 140, a fifth lens element 150, a filter 160 and an image surface 170. The optical photographing lens assembly includes five lens elements (110, 120, 130, 140 and 150) with no additional lens element disposed between each of the adjacent five lens elements.

The first lens element 110 with negative refractive power has an object-side surface 111 being concave in a paraxial region thereof and an image-side surface 112 being concave in a paraxial region thereof. The first lens element 110 is made of plastic material and has the object-side surface 111 being a freeform surface and the image-side surface 112 being aspheric. The object-side surface 111 of the first lens element 110 has one critical point in an off-axis region thereof and in a maximum image height direction.

The second lens element 120 with positive refractive power has an object-side surface 121 being convex in a paraxial region thereof and an image-side surface 122 being convex in a paraxial region thereof. The second lens element 120 is made of plastic material and has the object-side surface 121 and the image-side surface 122 being both aspheric.

The third lens element 130 with negative refractive power has an object-side surface 131 being concave in a paraxial region thereof and an image-side surface 132 being concave in a paraxial region thereof. The third lens element 130 is made of plastic material and has the object-side surface 131 and the image-side surface 132 being both aspheric.

The fourth lens element 140 with positive refractive power has an object-side surface 141 being convex in a paraxial region thereof and an image-side surface 142 being convex in a paraxial region thereof. The fourth lens element 140 is made of plastic material and has the object-side surface 141 and the image-side surface 142 being both aspheric.

The fifth lens element 150 with negative refractive power has an object-side surface 151 being convex in a paraxial region thereof and an image-side surface 152 being concave in a paraxial region thereof. The fifth lens element 150 is made of plastic material and has the object-side surface 151 being aspheric and the image-side surface 152 being a freeform surface. The object-side surface 151 of the fifth lens element 150 has one critical point in an off-axis region thereof and in the maximum image height direction. The image-side surface 152 of the fifth lens element 150 has one critical point in an off-axis region thereof and in the maximum image height direction.

The filter 160 is made of glass material and located between the fifth lens element 150 and the image surface 170, and will not affect the focal length of the optical photographing lens assembly. The image sensor 180 is disposed on or near the image surface 170 of the optical photographing lens assembly.

In this embodiment, the maximum image height direction corresponds to a diagonal direction D of a photosensitive area of the image sensor 180, but the present disclosure is not limited thereto.

The equation of the (axisymmetric) aspheric surface profiles of the aforementioned aspheric lens elements of the 1st embodiment is expressed as follows:

$$z ( r ) = \frac{\frac{{r}^{2}}{R}}{1 + \sqrt{1 - ( 1 + k ) {( \frac{r}{R} )}^{2}}} + {\sum }_{i} ( A i ) {r}^{i} ,$$

where,

z is a displacement in parallel with an optical axis from an intersection point between the aspheric surface and the optical axis to a point at a distance of r from the optical axis on the aspheric surface;

r is a vertical distance from the point on the aspheric surface to the optical axis;

R is the curvature radius in a paraxial region of the aspheric surface;

k is the conic coefficient; and

Ai is the i-th aspheric coefficient, and in the embodiments, i may be, but is not limited to, 4, 6, 8, 10, 12, 14, 16, 18, 20, 22 and 24.

The equation of the freeform surface profiles of the aforementioned freeform lens elements of the 1st embodiment is expressed as follows:

$$z ( x , y ) = \frac{\frac{{x}^{2}}{R x} + \frac{{y}^{2}}{R y}}{1 + \sqrt{1 - ( 1 + kx ) {( \frac{x}{R x} )}^{2} - ( 1 + ky ) {( \frac{y}{R y} )}^{2}}} + {\sum }_{i} ( \frac{Axi - Ayi}{2} ( 2 \frac{{x}^{2}}{{x}^{2} + {y}^{2}} - 1 ) + \frac{Axi + Ayi}{2} ) {( r ( x , y ) )}^{i} ,$$

where,

z is a displacement in parallel with the optical axis from an intersection point between the freeform surface and the optical axis to a point at (x, y) on the freeform surface;

r(x, y) is a vertical distance from the point on the freeform surface to the optical axis, and r(x, y)=sqrt(x²+y²);

x is the x-coordinate of the point on the freeform surface;

y is the y-coordinate of the point on the freeform surface;

Rx is the paraxial curvature radius of the freeform surface in the X-axis direction; Ry is the paraxial curvature radius of the freeform surface in the Y-axis direction;

kx is the conic coefficient in the X-axis direction;

ky is the conic coefficient in the Y-axis direction;

Axi is the i-th freeform coefficient in the X-axis direction, and in the embodiments, i may be, but is not limited to, 4, 6, 8, 10, 12, 14, 16, 18, 20, 22, 24 and 26; and

Ayi is the i-th freeform coefficient in the Y-axis direction, and in the embodiments, i may be, but is not limited to, 4, 6, 8, 10, 12, 14, 16, 18, 20, 22, 24 and 26.

In this and the following embodiments, the equation of the freeform surface profiles applied to the design of the freeform lens elements are not intended to limit the present disclosure. In other configurations, other equations of the freeform surface profiles, such as anamorphic asphere equation, Zernike or x-y polynomials, can also be applied to the design of freeform lens elements according to actual requirements.

In this embodiment, a direction of light travelling into the image surface 170 on the optical axis is the positive Z-axis direction, a direction corresponding to a lengthwise direction of the photosensitive area of the image sensor 180 is the X-axis direction, a direction corresponding to a widthwise direction of the photosensitive area of the image sensor 180 is the Y-axis direction, and a direction corresponding to the diagonal direction of the photosensitive area of the image sensor 180 is the D direction, but the present disclosure is not limited thereto.

In the optical photographing lens assembly of the image capturing unit according to the 1st embodiment, when a focal length of the optical photographing lens assembly corresponding to the diagonal direction D of the photosensitive area of the image sensor 180 is fD, a focal length of the optical photographing lens assembly corresponding to the lengthwise direction (the X-axis direction) of the photosensitive area of the image sensor 180 is fX, and a focal length of the optical photographing lens assembly corresponding to the widthwise direction (the Y-axis direction) of the photosensitive area of the image sensor 180 is fY, these parameters have the following values: fD=1.76 millimeters (mm), fX=1.76 mm, fY=1.76 mm.

When an f-number of the optical photographing lens assembly is Fno, the following condition is satisfied: Fno=2.32.

When half of a maximum field of view of the optical photographing lens assembly corresponding to the diagonal direction D of the photosensitive area of the image sensor 180 is HFOVD, half of a maximum field of view of the optical photographing lens assembly corresponding to the lengthwise direction of the photosensitive area of the image sensor 180 is HFOVX, and half of a maximum field of view of the optical photographing lens assembly corresponding to the widthwise direction of the photosensitive area of the image sensor 180 is HFOVY, these parameters have the following values: HFOVD=59.3 degrees (deg.), HFOVX=53.4 deg., HFOVY=44.4 deg.

When a maximum distance between the optical axis and the imaging position of the optical photographing lens assembly corresponding to the diagonal direction D of the photosensitive area of the image sensor 180 is ImgHD, a maximum distance between the optical axis and the imaging position of the optical photographing lens assembly corresponding to the lengthwise direction of the photosensitive area of the image sensor 180 is ImgHX, and a maximum distance between the optical axis and the imaging position of the optical photographing lens assembly corresponding to the widthwise direction of the photosensitive area of the image sensor 180 is ImgHY, these parameters have the following values: ImgHD=2.93 mm, ImgHX=2.36 mm, ImgHY=1.75 mm.

When an Abbe number of the second lens element 120 is V2, an Abbe number of the third lens element 130 is V3, and an Abbe number of the fourth lens element 140 is V4, the following condition is satisfied: (V2+V4)/V3=6.07.

When an Abbe number of the first lens element 110 is V1, the Abbe number of the second lens element 120 is V2, the Abbe number of the third lens element 130 is V3, the Abbe number of the fourth lens element 140 is V4, an Abbe number of the fifth lens element 150 is V5, an Abbe number of the i-th lens element is Vi, a refractive index of the first lens element 110 is N1, a refractive index of the second lens element 120 is N2, a refractive index of the third lens element 130 is N3, a refractive index of the fourth lens element 140 is N4, a refractive index of the fifth lens element 150 is N5, a refractive index of the i-th lens element is Ni, and a minimum value of Vi/Ni is (Vi/Ni)min, the following condition is satisfied: (Vi/Ni)min=10.98, wherein i=1, 2, 3, 4 or 5. In this embodiment, among the first lens element 110 through the fifth lens element 150, a ratio of the Abbe number to the refractive index of the third lens element 130 and a ratio of the Abbe number to the refractive index of the fifth lens element 150 are the same and both smaller than ratios of Abbe number to refractive index of the other lens elements, and (Vi/Ni)min is equal to the ratio of the Abbe number to the refractive index of the third lens element 130 and the ratio of the Abbe number to the refractive index of the fifth lens element 150.

When the Abbe number of the third lens element 130 is V3, and the Abbe number of the fifth lens element 150 is V5, the following condition is satisfied: V3+V5=36.9.

When a central thickness of the first lens element 110 is CT1, a central thickness of the second lens element 120 is CT2, a central thickness of the third lens element 130 is CT3, a central thickness of the fourth lens element 140 is CT4, and a central thickness of the fifth lens element 150 is CT5, the following condition is satisfied: (CT1+CT2+CT4)/(CT3+CT5)=3.95.

When the central thickness of the first lens element 110 is CT1, the central thickness of the second lens element 120 is CT2, the central thickness of the third lens element 130 is CT3, the central thickness of the fourth lens element 140 is CT4, and the central thickness of the fifth lens element 150 is CT5, the following condition is satisfied: (CT2+CT3+CT4+CT5)/CT1=3.43.

When the central thickness of the first lens element 110 is CT1, and the central thickness of the fourth lens element 140 is CT4, the following condition is satisfied: CT1/CT4=0.86.

When an axial distance between the second lens element 120 and the third lens element 130 is T23, and an axial distance between the third lens element 130 and the fourth lens element 140 is T34, the following condition is satisfied: T34/T23=1.57. In this embodiment, an axial distance between two adjacent lens elements is a distance in a paraxial region between two adjacent lens surfaces of the two adjacent lens elements.

When an axial distance between the object-side surface 111 of the first lens element 110 and the image surface 170 is TL, and the focal length of the optical photographing lens assembly in the maximum image height direction is f, the following condition is satisfied: TL/f=3.10. In this embodiment, the optical photographing lens assembly has the maximum image height in the diagonal direction D of the photosensitive area of the image sensor 180, and the focal length of the optical photographing lens assembly in the maximum image height direction (f) refers to the focal length of the optical photographing lens assembly corresponding to the diagonal direction D of the photosensitive area of the image sensor 180 (fD).

When the axial distance between the object-side surface 111 of the first lens element 110 and the image surface 170 is TL, and a maximum image height of the optical photographing lens assembly is ImgH, the following condition is satisfied: TL/ImgH=1.86. In this embodiment, the maximum image height of the optical photographing lens assembly (ImgH) refers to the maximum distance between the optical axis and the imaging position of the optical photographing lens assembly corresponding to the diagonal direction D of the photosensitive area of the image sensor 180 (ImgHD).

When a paraxial curvature radius of the object-side surface 151 of the fifth lens element 150 in the maximum image height direction is R9, and a paraxial curvature radius of the image-side surface 152 of the fifth lens element 150 in the maximum image height direction is R10, the following condition is satisfied: (R9+R10)/(R9−R10)=2.96.

When a paraxial curvature radius of the object-side surface 111 of the first lens element 110 in the maximum image height direction is R1, and the focal length of the optical photographing lens assembly in the maximum image height direction is f, the following condition is satisfied: R1/f=−1.51.

When the paraxial curvature radius of the object-side surface 111 of the first lens element 110 in the maximum image height direction is R1, and a focal length of the first lens element 110 in the maximum image height direction is f1, the following condition is satisfied: R1/f1=0.74.

When a paraxial curvature radius of the image-side surface 142 of the fourth lens element 140 in the maximum image height direction is R8, and the focal length of the optical photographing lens assembly in the maximum image height direction is f, the following condition is satisfied: R8/f=−0.62.

When the focal length of the optical photographing lens assembly in the maximum image height direction is f, and a focal length of the fifth lens element 150 in the maximum image height direction is f5, the following condition is satisfied: f/f5=−0.79.

When the focal length of the optical photographing lens assembly in the maximum image height direction is f, and a composite focal length of the first lens element 110, the second lens element 120 and the third lens element 130 in the maximum image height direction is f123, the following condition is satisfied: f123/f=1.82.

When a focal length of the fourth lens element 140 in a maximum image height direction is f4, and the central thickness of the fourth lens element 140 is CT4, the following condition is satisfied: f4/CT4=2.47.

When the focal length of the optical photographing lens assembly in the maximum image height direction is f, and a composite focal length of the fourth lens element 140 and the fifth lens element 150 in the maximum image height direction is f45, the following condition is satisfied: f45/f=2.80.

When half of a maximum field of view of the optical photographing lens assembly is HFOV, the following condition is satisfied: HFOV=59.3 degrees. In this embodiment, half of the maximum field of view of the optical photographing lens assembly (HFOV) refers to half of the maximum field of view of the optical photographing lens assembly corresponding to the diagonal direction D of the photosensitive area of the image sensor 180 (HFOVD).

When a maximum distance between the optical axis and a boundary of an optically effective area of the object-side surface 111 of the first lens element 110 is Y11, and a maximum distance between the optical axis and a boundary of an optically effective area of the image-side surface 152 of the fifth lens element 150 is Y52, the following condition is satisfied: Y52/Y11=1.32.

When a minimum value among distances between the optical axis and a boundary of an optically effective area of one lens surface is Ymin, a displacement in parallel with the optical axis from an intersection point between the lens surface and the optical axis to a position at a distance of Ymin from the optical axis on the lens surface is SAG, a maximum value among all the displacements SAG is SAG_MAX, a minimum value among all the displacements SAG is SAG_MIN, and an absolute difference between SAG_MAX and SAG_MIN is |dSAG|max, the object-side surface 111 of the first lens element 110 satisfies the following condition: |dSAG|max=0.88 um; and the image-side surface 152 of the fifth lens element 150 satisfies the following condition: |dSAG|max=14.89 um.

When the absolute difference between SAG_MAX and SAG_MIN is |dSAG|max, and a central thickness of one freeform lens element is CTF, the object-side surface 111 of the first lens element 110 satisfies the following condition: |dSAG|max/CTF=1.33E-03, and the image-side surface 152 of the fifth lens element 150 satisfies the following condition: |dSAG|max/CTF=4.46E-02.

The detailed optical data of the 1st embodiment are shown in Table 1, the aspheric surface data are shown in Table 2 and the freeform surface data are shown in Table 3 below.

TABLE 1
1st Embodiment
fD = 1.76 mm, fX = 1.76 mm, fY = 1.76 mm, Fno = 2.32
HFOVD = 59.3 deg., HFOVX = 53.4 deg., HFOVY = 44.4 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −2.6677 | −2.6646 | (FFS) | 0.665 | Plastic | 1.545 | 56.1 | −3.62 | −3.62 |
| 2 | | 8.2534 | | (ASP) | 0.852 | | | | | |
| 3 | Ape. Stop | Plano | | | −0.039 | | | | | |
| 4 | Lens 2 | 2.3809 | | (ASP) | 0.907 | Plastic | 1.544 | 56.0 | 1.92 | |
| 5 | | −1.6183 | | (ASP) | 0.216 | | | | | |
| 6 | Lens 3 | −212.3142 | | (ASP) | 0.260 | Plastic | 1.679 | 18.4 | −7.64 | |
| 7 | | 5.3227 | | (ASP) | 0.339 | | | | | |
| 8 | Lens 4 | 17.2830 | | (ASP) | 0.777 | Plastic | 1.544 | 56.0 | 1.92 | |
| 9 | | −1.0921 | | (ASP) | 0.020 | | | | | |
| 10 | Lens 5 | 1.1901 | | (ASP) | 0.334 | Plastic | 1.679 | 18.4 | −2.22 | −2.22 |
| 11 | | 0.5892 | 0.5899 | (FFS) | 0.511 | | | | | |

| | | | | | | | |
|---|---|---|---|---|---|---|---|
| 12 | Filter | Plano | 0.210 | Glass | 1.517 | 64.2 | — |
| 13 | | Plano | 0.410 | | | | |
| 14 | Image | Plano | — | | | | |

Note:
Reference wavelength is 587.6 nm (d-line).

TABLE 2
Aspheric Coefficients

| Surface # | 2 | 4 | 5 | 6 |
|---|---|---|---|---|
| k= | 6.63346E+00 | 0.00000E+00 | 2.24076E−01 | −9.90000E+01 |
| A4= | 6.012126E−01 | −5.495774E−02 | −2.485100E−01 | −3.540326E−01 |
| A6= | −2.349906E+00 | 6.281119E−01 | 2.601063E−01 | 1.063316E−01 |
| A8= | 1.719376E+01 | −1.692190E+01 | −3.664628E−01 | 8.873563E−01 |
| A10= | −7.957765E+01 | 2.043021E+02 | −8.818583E−01 | −3.759282E+00 |
| A12= | 2.267024E+02 | −1.493594E+03 | 1.462292E+00 | 6.853926E+00 |
| A14= | −3.990882E+02 | 6.587888E+03 | 4.630695E−02 | −7.680991E+00 |
| A16= | 4.259016E+02 | −1.705999E+04 | −1.181290E+00 | 3.551037E+00 |
| A18= | −2.519085E+02 | 2.361338E+04 | — | — |
| A20= | 5.790548E+01 | −1.337107E+04 | — | — |
| A22= | 1.075882E+01 | — | — | — |
| A24= | −5.706941E+00 | — | — | — |
| Surface # | 7 | 8 | 9 | 10 |
| k= | 4.68789E+00 | 0.00000E+00 | −7.43298E+00 | −9.04568E+00 |
| A4= | −1.022495E−01 | 3.284378E−01 | 2.407380E−01 | −3.171420E−02 |
| A6= | −1.639047E−01 | −5.800685E−01 | −2.999209E−01 | −1.649166E−01 |
| A8= | 5.635294E−01 | 6.362284E−01 | 2.675461E−01 | 1.319010E−01 |
| A10= | −4.590784E−01 | −5.176996E−01 | −2.208042E−01 | −3.354498E−02 |
| A12= | −2.821177E−01 | 3.080480E−01 | 1.357114E−01 | −6.440382E−03 |
| A14= | 6.788532E−01 | −1.242969E−01 | −5.218690E−02 | 6.752361E−03 |
| A16= | −3.982331E−01 | 3.123281E−02 | 1.188905E−02 | −1.993577E−03 |
| A18= | 8.013122E−02 | −4.322786E−03 | −1.526041E−03 | 2.996921E−04 |
| A20= | — | 2.450763E−04 | 9.808104E−05 | −2.311243E−05 |
| A22= | — | — | −2.281799E−06 | 7.214728E−07 |

TABLE 3
Freeform Coefficients

| Surface # | 1 | 11 | Surface # | 1 | 11 |
|---|---|---|---|---|---|
| kx= | 0.00000E+00 | −4.28887E+00 | ky= | −1.02499E−06 | −4.23853E+00 |
| Ax4= | 3.215950E−01 | −1.317795E−01 | Ay4= | 3.217278E−01 | −1.260829E−01 |
| Ax6= | −3.275293E−01 | 1.198981E−01 | Ay6= | −3.276646E−01 | 1.147151E−01 |
| Ax8= | 3.546100E−01 | −1.723913E−01 | Ay8= | 3.547564E−01 | −1.649391E−01 |
| Ax10= | −3.201050E−01 | 1.758572E−01 | Ay10= | −3.202372E−01 | 1.682552E−01 |
| Ax12= | 2.182247E−01 | −1.118793E−01 | Ay12= | 2.183148E−01 | −1.070430E−01 |
| Ax14= | −1.052810E−01 | 4.618967E−02 | Ay14= | −1.053245E−01 | 4.419298E−02 |
| Ax16= | 3.430992E−02 | −1.274935E−02 | Ay16= | 3.432409E−02 | −1.219822E−02 |
| Ax18= | −7.134279E−03 | 2.370854E−03 | Ay18= | −7.137225E−03 | 2.268366E−03 |
| Ax20= | 8.514545E−04 | −2.926252E−04 | Ay20= | 8.518061E−04 | −2.799756E−04 |
| Ax22= | −4.433496E−05 | 2.291637E−05 | Ay22= | −4.435326E−05 | 2.192574E−05 |
| Ax24= | — | −1.027625E−06 | Ay24= | — | −9.832030E−07 |
| Ax26= | — | 2.002842E−08 | Ay26= | — | 1.916263E−08 |

In Table 1, the curvature radius, the thickness and the focal length are shown in millimeters (mm). Surface numbers 0-14 represent the surfaces sequentially arranged from the object side to the image side along the optical axis. The curvature radius and the focal length in the X-axis direction (X-dir.) are given in Table 1 only when the curvature radius and the focal length of the surface in the X-axis direction may be different from that in the Y-axis direction (Y-dir.). In Table 2, k represents the conic coefficient of the equation of the aspheric surface profiles. A4-A24 represent the axisymmetric aspheric coefficients ranging from the 4th order to the 24th order. In Table 3, kx represents the conic coefficient of the equation of the freeform surface profiles in the X-axis direction, and ky represents the conic coefficient of the equation of the freeform surface profiles in the Y-axis direction. Ax4-Ax26 represent the freeform coefficients ranging from the 4th order to the 26th order in the X-axis direction, and Ay4-Ay26 represent the freeform coefficients ranging from the 4th order to the 26th order in the Y-axis direction. The tables presented below for each embodiment are the corresponding schematic parameter and aberration curves, and the definitions of the tables are the same as Table 1, Table 2 and Table 3 of the 1st embodiment. Therefore, an explanation in this regard will not be provided again.

### 2nd Embodiment

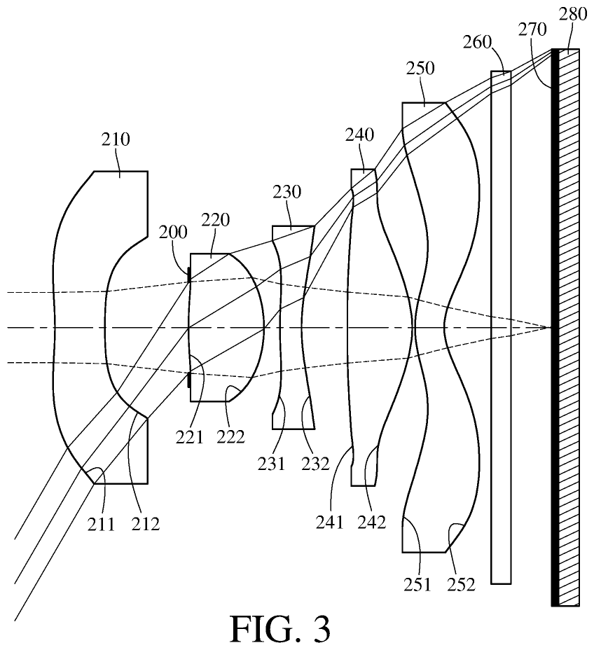

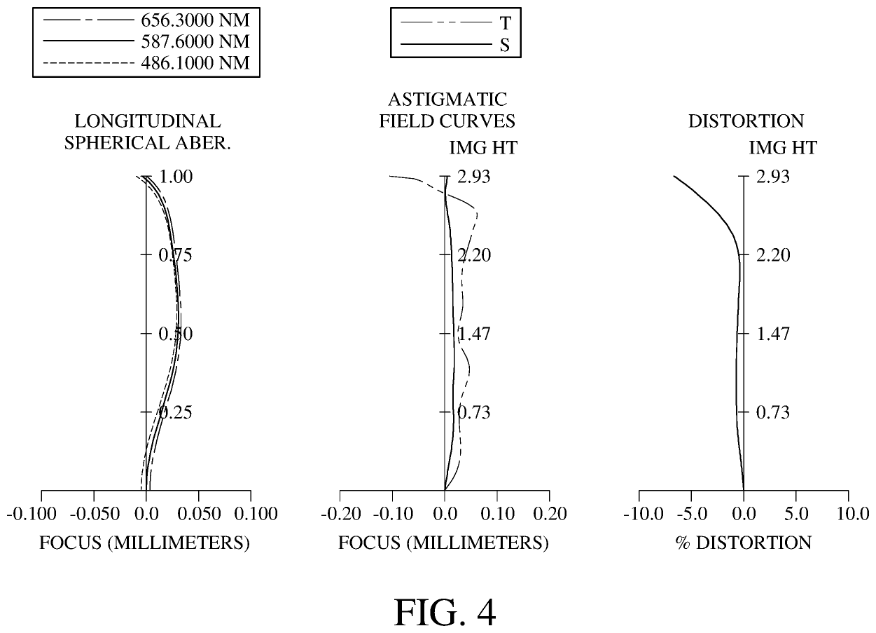

FIG. 3 is a cross-sectional view of an image capturing unit corresponding to a diagonal direction of a photosensitive area of an image sensor according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit includes the optical photographing lens assembly (its reference numeral is omitted) of the present disclosure and an image sensor 280. The optical photographing lens assembly includes, in order from an object side to an image side along an optical path, a first lens element 210, an aperture stop 200, a second lens element 220, a third lens element 230, a fourth lens element 240, a fifth lens element 250, a filter 260 and an image surface 270. The optical photographing lens assembly includes five lens elements (210, 220, 230, 240 and 250) with no additional lens element disposed between each of the adjacent five lens elements.

The first lens element 210 with negative refractive power has an object-side surface 211 being concave in a paraxial region thereof and an image-side surface 212 being concave in a paraxial region thereof. The first lens element 210 is made of plastic material and has the object-side surface 211 and the image-side surface 212 being both aspheric. The object-side surface 211 of the first lens element 210 has one critical point in an off-axis region thereof and in a maximum image height direction.

The second lens element 220 with positive refractive power has an object-side surface 221 being convex in a paraxial region thereof and an image-side surface 222 being convex in a paraxial region thereof. The second lens element 220 is made of plastic material and has the object-side surface 221 and the image-side surface 222 being both aspheric.

The third lens element 230 with negative refractive power has an object-side surface 231 being convex in a paraxial region thereof and an image-side surface 232 being concave in a paraxial region thereof. The third lens element 230 is made of plastic material and has the object-side surface 231 and the image-side surface 232 being both aspheric.

The fourth lens element 240 with positive refractive power has an object-side surface 241 being convex in a paraxial region thereof and an image-side surface 242 being convex in a paraxial region thereof. The fourth lens element 240 is made of plastic material and has the object-side surface 241 and the image-side surface 242 being both aspheric.

The fifth lens element 250 with negative refractive power has an object-side surface 251 being convex in a paraxial region thereof and an image-side surface 252 being concave in a paraxial region thereof. The fifth lens element 250 is made of plastic material and has the object-side surface 251 being aspheric and the image-side surface 252 being a freeform surface. The object-side surface 251 of the fifth lens element 250 has one critical point in an off-axis region thereof and in the maximum image height direction. The image-side surface 252 of the fifth lens element 250 has one critical point in an off-axis region thereof and in the maximum image height direction.

The filter 260 is made of glass material and located between the fifth lens element 250 and the image surface 270, and will not affect the focal length of the optical photographing lens assembly. The image sensor 280 is disposed on or near the image surface 270 of the optical photographing lens assembly.

In this embodiment, the maximum image height direction corresponds to a diagonal direction D of a photosensitive area of the image sensor 280.

In this embodiment, the image-side surface 252 of the fifth lens element 250 satisfies the following conditions: |dSAG|max=3.27 um; and |dSAG|max/CTF=1.06E-02.

The detailed optical data of the 2nd embodiment are shown in Table 4, the aspheric surface data are shown in Table 5 and the freeform surface data are shown in Table 6 below.

TABLE 4
2nd Embodiment
fD = 1.80 mm, fX = 1.80 mm, fY = 1.80 mm, Fno = 2.40
HFOVD = 59.9 deg., HFOVX = 52.6 deg., HFOVY = 44.1 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −3.5905 | | (ASP) | 0.532 | Plastic | 1.545 | 56.1 | −4.11 | |
| 2 | | 6.2525 | | (ASP) | 0.892 | | | | | |
| 3 | Ape. Stop | Plano | | | −0.002 | | | | | |
| 4 | Lens 2 | 3.6685 | | (ASP) | 0.803 | Plastic | 1.545 | 56.1 | 1.89 | |
| 5 | | −1.3209 | | (ASP) | 0.170 | | | | | |
| 6 | Lens 3 | 3.8336 | | (ASP) | 0.230 | Plastic | 1.686 | 18.4 | −6.14 | |
| 7 | | 1.9581 | | (ASP) | 0.488 | | | | | |
| 8 | Lens 4 | 9992.5080 | | (ASP) | 0.690 | Plastic | 1.545 | 56.1 | 2.05 | |
| 9 | | −1.1156 | | (ASP) | 0.030 | | | | | |
| 10 | Lens 5 | 1.0395 | | (ASP) | 0.310 | Plastic | 1.660 | 20.4 | −2.62 | −2.62 |
| 11 | | 0.5724 | 0.5724 | (FFS) | 0.501 | | | | | |

| | | | | | | | |
|---|---|---|---|---|---|---|---|
| 12 | Filter | Plano | 0.210 | Glass | 1.517 | 64.2 | — |
| 13 | | Plano | 0.435 | | | | |
| 14 | Image | Plano | — | | | | |

Note:
Reference wavelength is 587.6 nm (d-line).

TABLE 5
Aspheric Coefficients

| Surface # | 1 | 2 | 4 | 5 | 6 |
|---|---|---|---|---|---|
| k= | 0.00000E+00 | 8.64447E+00 | −1.66746E+01 | 5.25344E−01 | 2.07722E+00 |
| A4= | 3.119563E−01 | 5.735605E−01 | −6.886130E−02 | −1.793509E−01 | −4.361121E−01 |
| A6= | −3.016952E−01 | −2.050908E+00 | −3.393906E−01 | −5.792383E−02 | 7.241191E−01 |
| A8= | 3.297453E−01 | 1.507263E+01 | 9.572436E−01 | 2.015328E+00 | −1.742018E+00 |
| A10= | −3.248170E−01 | −7.207347E+01 | −5.446880E+00 | −1.083423E+01 | 3.372963E+00 |
| A12= | 2.607876E−01 | 2.200937E+02 | 5.380449E+00 | 2.445338E+01 | −4.835859E+00 |
| A14= | −1.549939E−01 | −4.343553E+02 | — | −2.705640E+01 | 3.828648E+00 |
| A16= | 6.355415E−02 | 5.565740E+02 | — | 1.129481E+01 | −1.152293E+00 |
| A18= | −1.675296E−02 | −4.539848E+02 | — | — | — |
| A20= | 2.533162E−03 | 2.241443E+02 | — | — | — |
| A22= | −1.665068E−04 | −6.025687E+01 | — | — | — |
| A24= | — | 6.674440E+00 | — | — | — |
| Surface # | 7 | 8 | 9 | 10 | — |
| k= | −4.15055E−01 | 0.00000E+00 | −3.00998E+00 | −5.26761E+00 | — |
| A4= | −3.064752E−01 | 1.520898E−01 | 2.493458E−01 | −2.024565E−01 | — |
| A6= | 5.112348E−01 | −2.657730E−01 | −5.159633E−01 | −5.788324E−02 | — |
| A8= | −1.155657E+00 | 2.181841E−01 | 6.477284E−01 | 1.732949E−01 | — |
| A10= | 2.416155E+00 | −7.258234E−02 | −5.587841E−01 | −1.194508E−01 | — |
| A12= | −3.571478E+00 | −1.855467E−02 | 3.507305E−01 | 4.583165E−02 | — |
| A14= | 3.220439E+00 | 3.322445E−02 | −1.457786E−01 | −1.116481E−02 | — |
| A16= | −1.570954E+00 | −1.753898E−02 | 3.594056E−02 | 1.777623E−03 | — |
| A18= | 3.182687E−01 | 4.617317E−03 | −4.606270E−03 | −1.798310E−04 | — |
| A20= | — | −5.156965E−04 | 2.264949E−04 | 1.046604E−05 | — |
| A22= | — | — | — | −2.653693E−07 | — |

TABLE 6
Freeform Coefficients

| Surface # | 11 | Surface # | 11 |
|---|---|---|---|
| kx= | −3.19296E+00 | ky= | −3.19296E+00 |
| Ax4= | −2.497000E−01 | Ay4= | −2.504796E−01 |
| Ax6= | 1.852500E−01 | Ay6= | 1.852500E−01 |
| Ax8= | −1.058729E−01 | Ay8= | −1.058729E−01 |
| Ax10= | 4.950835E−02 | Ay10= | 4.950835E−02 |
| Ax12= | −1.947340E−02 | Ay12= | −1.947340E−02 |
| Ax14= | 6.494940E−03 | Ay14= | 6.494940E−03 |
| Ax16= | −1.798574E−03 | Ay16= | −1.798574E−03 |
| Ax18= | 3.902035E−04 | Ay18= | 3.902035E−04 |
| Ax20= | −6.156933E−05 | Ay20= | −6.156933E−05 |
| Ax22= | 6.485794E−06 | Ay22= | 6.485794E−06 |
| Ax24= | −4.017963E−07 | Ay24= | −4.017963E−07 |
| Ax26= | 1.096257E−08 | Ay26= | 1.096257E−08 |

In the 2nd embodiment, the equations of the freeform surface profiles and the axisymmetric aspheric surface profiles of the aforementioned lens elements are the same as the equations of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 4, Table 5 and Table 6 as the following values and satisfy the following conditions:

2nd Embodiment

| | | | |
|---|---|---|---|
| fD [mm] | 1.80 | T34/T23 | 2.87 |
| fX [mm] | 1.80 | TL/f | 2.94 |
| fY [mm] | 1.80 | TL/ImgH | 1.80 |
| Fno | 2.40 | (R9 + R10)/(R9 − R10) | 3.45 |
| HFOVD [deg.] | 59.9 | R1/f | −2.00 |
| HFOVX [deg.] | 52.6 | R1/f1 | 0.87 |
| HFOVY [deg.] | 44.1 | R8/f | −0.62 |
| ImgHD [mm] | 2.93 | f/f5 | −0.69 |
| ImgHX [mm] | 2.36 | f123/f | 1.82 |
| ImgHY [mm] | 1.75 | f4/CT4 | 2.97 |
| (V2 + V4)/V3 | 6.10 | f45/f | 2.55 |
| (Vi/Ni) min | 10.90 | HFOV [deg.] | 59.9 |
| V3 + V5 | 38.8 | Y52/Y11 | 1.44 |
| (CT1 + CT2 + CT4)/ | 3.75 | \|dSAG\|max [um] | 3.27 |
| (CT3 + CT5) | | | |
| (CT2 + CT3 + CT4 + | 3.82 | \|dSAG\|max/CTF | 1.06E−02 |
| CT5)/CT1 | | | |
| CT1/CT4 | 0.77 | — | — |

### 3rd Embodiment

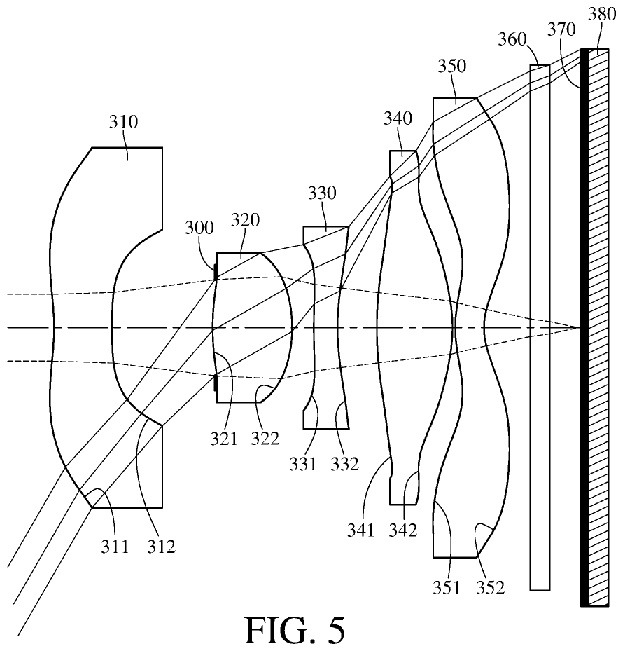

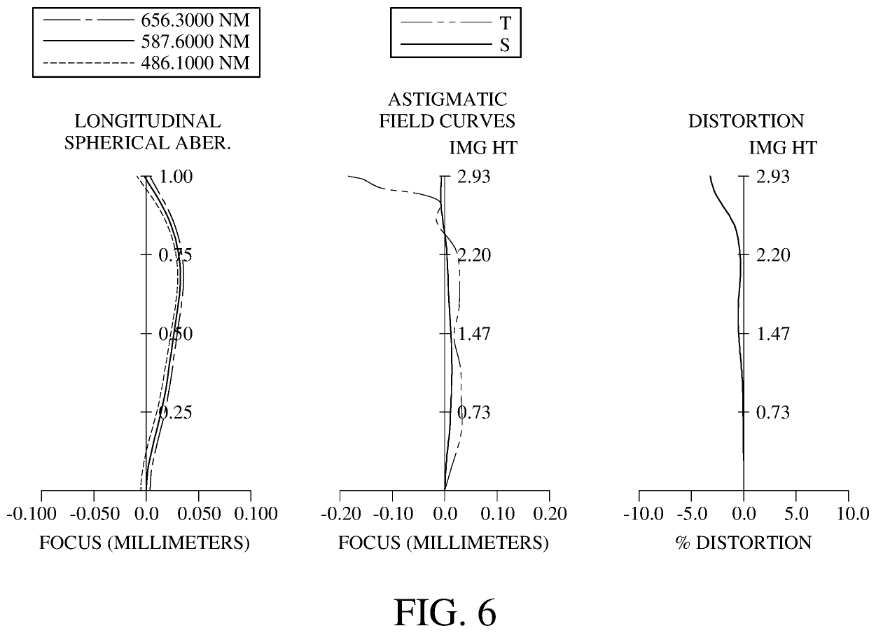

FIG. 5 is a cross-sectional view of an image capturing unit corresponding to a diagonal direction of a photosensitive area of an image sensor according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit includes the optical photographing lens assembly (its reference numeral is omitted) of the present disclosure and an image sensor 380. The optical photographing lens assembly includes, in order from an object side to an image side along an optical path, a first lens element 310, an aperture stop 300, a second lens element 320, a third lens element 330, a fourth lens element 340, a fifth lens element 350, a filter 360 and an image surface 370. The optical photographing lens assembly includes five lens elements (310, 320, 330, 340 and 350) with no additional lens element disposed between each of the adjacent five lens elements.

The first lens element 310 with negative refractive power has an object-side surface 311 being concave in a paraxial region thereof and an image-side surface 312 being concave in a paraxial region thereof. The first lens element 310 is made of plastic material and has the object-side surface 311 and the image-side surface 312 being both aspheric. The object-side surface 311 of the first lens element 310 has one critical point in an off-axis region thereof and in a maximum image height direction.

The second lens element 320 with positive refractive power has an object-side surface 321 being convex in a paraxial region thereof and an image-side surface 322 being convex in a paraxial region thereof. The second lens element 320 is made of plastic material and has the object-side surface 321 and the image-side surface 322 being both aspheric.

The third lens element 330 with negative refractive power has an object-side surface 331 being convex in a paraxial region thereof and an image-side surface 332 being concave in a paraxial region thereof. The third lens element 330 is made of plastic material and has the object-side surface 331 and the image-side surface 332 being both aspheric.

The fourth lens element 340 with positive refractive power has an object-side surface 341 being convex in a paraxial region thereof and an image-side surface 342 being convex in a paraxial region thereof. The fourth lens element 340 is made of plastic material and has the object-side surface 341 and the image-side surface 342 being both aspheric.

The fifth lens element 350 with negative refractive power has an object-side surface 351 being convex in a paraxial region thereof and an image-side surface 352 being concave in a paraxial region thereof. The fifth lens element 350 is made of plastic material and has the object-side surface 351 being aspheric and the image-side surface 352 being a freeform surface. The object-side surface 351 of the fifth lens element 350 has two critical points in an off-axis region thereof and in the maximum image height direction. The image-side surface 352 of the fifth lens element 350 has one critical point in an off-axis region thereof and in the maximum image height direction.

The filter 360 is made of glass material and located between the fifth lens element 350 and the image surface 370, and will not affect the focal length of the optical photographing lens assembly. The image sensor 380 is disposed on or near the image surface 370 of the optical photographing lens assembly.

In this embodiment, the maximum image height direction corresponds to a diagonal direction D of a photosensitive area of the image sensor 380.

In this embodiment, the image-side surface 352 of the fifth lens element 350 satisfies the following conditions: |dSAG|max=3.63 um; and |dSAG|max/CTF=1.17E-02.

The detailed optical data of the 3rd embodiment are shown in Table 7, the aspheric surface data are shown in Table 8 and the freeform surface data are shown in Table 9 below.

TABLE 7
3rd Embodiment
fD = 1.73 mm, fX = 1.73 mm, fY = 1.73 mm, Fno = 2.40
HFOVD = 59.9 deg., HFOVX = 53.5 deg., HFOVY = 45.1 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −2.5171 | | (ASP) | 0.627 | Plastic | 1.545 | 56.1 | −3.51 | |
| 2 | | 8.6969 | | (ASP) | 1.114 | | | | | |
| 3 | Ape. Stop | Plano | | | −0.026 | | | | | |
| 4 | Lens 2 | 2.4823 | | (ASP) | 0.859 | Plastic | 1.544 | 56.0 | 1.91 | |
| 5 | | −1.5660 | | (ASP) | 0.235 | | | | | |
| 6 | Lens 3 | 5.0721 | | (ASP) | 0.256 | Plastic | 1.686 | 18.4 | −6.68 | |
| 7 | | 2.3581 | | (ASP) | 0.426 | | | | | |
| 8 | Lens 4 | 4.3585 | | (ASP) | 0.818 | Plastic | 1.544 | 56.0 | 2.20 | |
| 9 | | −1.5409 | | (ASP) | 0.030 | | | | | |
| 10 | Lens 5 | 1.3722 | | (ASP) | 0.310 | Plastic | 1.669 | 19.5 | −2.59 | −2.59 |
| 11 | | 0.6963 | 0.6963 | (FFS) | 0.501 | | | | | |

| | | | | | | | |
|---|---|---|---|---|---|---|---|
| 12 | Filter | Plano | 0.210 | Glass | 1.517 | 64.2 | — |
| 13 | | Plano | 0.338 | | | | |
| 14 | Image | Plano | — | | | | |

Note:
Reference wavelength is 587.6 nm (d-line).

TABLE 8
Aspheric Coefficients

| Surface # | 1 | 2 | 4 | 5 | 6 |
|---|---|---|---|---|---|
| k= | 0.00000E+00 | −9.90000E+01 | 0.00000E+00 | −2.35496E−01 | 1.12208E+01 |
| A4= | 3.317200E−01 | 4.639607E−01 | −1.572599E−01 | −2.311117E−01 | −4.167388E−01 |
| A6= | −3.184651E−01 | −1.860714E−01 | 1.887085E+00 | 3.935449E−01 | 9.398828E−01 |
| A8= | 3.029795E−01 | −1.234181E+00 | −2.990535E+01 | −1.451032E+00 | −2.715380E+00 |
| A10= | −2.297690E−01 | 9.793065E+00 | 2.573523E+02 | 1.613347E+00 | 4.801935E+00 |
| A12= | 1.303832E−01 | −3.713084E+01 | −1.388645E+03 | 5.928340E−02 | −5.797452E+00 |
| A14= | −5.295792E−02 | 8.720175E+01 | 4.696526E+03 | −1.829621E+00 | 3.802077E+00 |
| A16= | 1.477598E−02 | −1.311793E+02 | −9.691122E+03 | 7.997558E−01 | −9.046560E−01 |
| A18= | −2.672682E−03 | 1.259341E+02 | 1.110900E+04 | — | — |
| A20= | 2.810009E−04 | −7.415214E+01 | −5.433613E+03 | — | — |
| A22= | −1.300500E−05 | 2.422164E+01 | — | — | — |
| A24= | — | −3.340293E+00 | — | — | — |
| Surface # | 7 | 8 | 9 | 10 | — |
| k= | 5.12068E−01 | 0.00000E+00 | −3.78525E+00 | −9.68438E+00 | — |
| A4= | −2.746482E−01 | 6.312785E−02 | 3.182010E−01 | −1.588402E−01 | — |
| A6= | 5.160318E−01 | −1.869255E−01 | −6.929520E−01 | −2.279466E−01 | — |
| A8= | −8.826743E−01 | 1.590013E−01 | 8.313000E−01 | 3.741619E−01 | — |
| A10= | 1.063814E+00 | −4.829475E−02 | −6.809738E−01 | −2.452937E−01 | — |
| A12= | −1.008520E+00 | −2.787544E−02 | 3.884911E−01 | 9.535705E−02 | — |
| A14= | 7.364819E−01 | 3.750809E−02 | −1.466501E−01 | −2.390246E−02 | — |
| A16= | −3.366654E−01 | −1.785898E−02 | 3.505635E−02 | 3.895635E−03 | — |
| A18= | 6.807971E−02 | 4.128752E−03 | −5.051378E−03 | −3.975117E−04 | — |
| A20= | — | −3.869921E−04 | 3.984135E−04 | 2.296127E−05 | — |
| A22= | — | — | −1.323252E−05 | −5.702984E−07 | — |

TABLE 9
Freeform Coefficients

| Surface # | 11 | Surface # | 11 |
|---|---|---|---|
| kx= | −3.95420E+00 | ky= | −3.95420E+00 |
| Ax4= | −2.224000E−01 | Ay4= | −2.232337E−01 |
| Ax6= | 1.052594E−01 | Ay6= | 1.052594E−01 |
| Ax8= | 6.086610E−03 | Ay8= | 6.086610E−03 |
| Ax10= | −4.962885E−02 | Ay10= | −4.962885E−02 |
| Ax12= | 4.192841E−02 | Ay12= | 4.192841E−02 |
| Ax14= | −2.033674E−02 | Ay14= | −2.033674E−02 |
| Ax16= | 6.399989E−03 | Ay16= | 6.399989E−03 |
| Ax18= | −1.337118E−03 | Ay18= | −1.337118E−03 |
| Ax20= | 1.833028E−04 | Ay20= | 1.833028E−04 |
| Ax22= | −1.577557E−05 | Ay22= | −1.577557E−05 |
| Ax24= | 7.694633E−07 | Ay24= | 7.694633E−07 |
| Ax26= | −1.614698E−08 | Ay26= | −1.614698E−08 |

In the 3rd embodiment, the equations of the freeform surface profiles and the axisymmetric aspheric surface profiles of the aforementioned lens elements are the same as the equations of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 7, Table 8 and Table 9 as the following values and satisfy the following conditions:

3rd Embodiment

| | | | |
|---|---|---|---|
| fD [mm] | 1.73 | T34/T23 | 1.81 |
| fX [mm] | 1.73 | TL/f | 3.29 |
| fY [mm] | 1.73 | TL/ImgH | 1.94 |
| Fno | 2.40 | (R9 + R10)/(R9 − R10) | 3.06 |
| HFOVD [deg.] | 59.9 | R1/f | −1.45 |
| HFOVX [deg.] | 53.5 | R1/f1 | 0.72 |
| HFOVY [deg.] | 45.1 | R8/f | −0.89 |
| ImgHD [mm] | 2.93 | f/f5 | −0.67 |
| ImgHX [mm] | 2.36 | f123/f | 1.72 |
| ImgHY [mm] | 1.75 | T4/CT4 | 2.69 |
| (V2 + V4)/V3 | 6.09 | f45/f | 3.20 |
| (Vi/Ni) min | 10.90 | HFOV [deg.] | 59.9 |
| V3 + V5 | 37.8 | Y52/Y11 | 1.28 |
| (CT1 + CT2 + CT4)/ | 4.07 | \|dSAG\|max [um] | 3.63 |
| (CT3 + CT5) | | | |
| (CT2 + CT3 + CT4 + | 3.58 | \|dSAG\|max/CTF | 1.17E−02 |
| CT5)/CT1 | | | |
| CT1/CT4 | 0.77 | — | — |

### 4th Embodiment

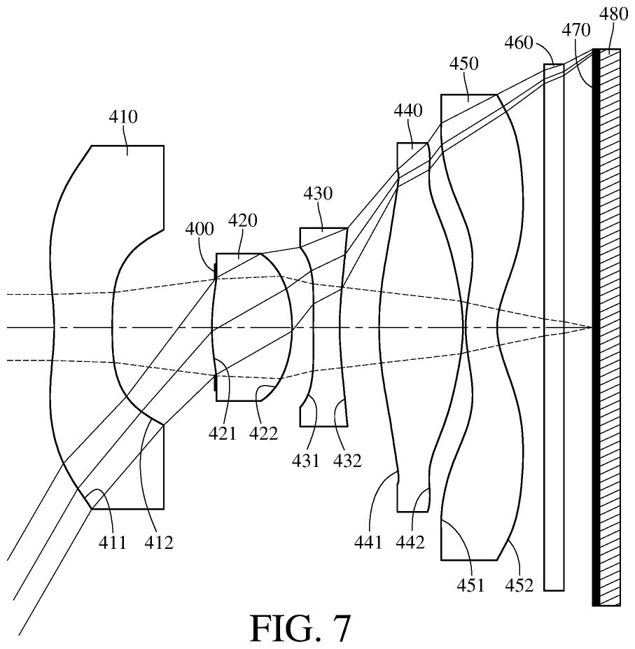

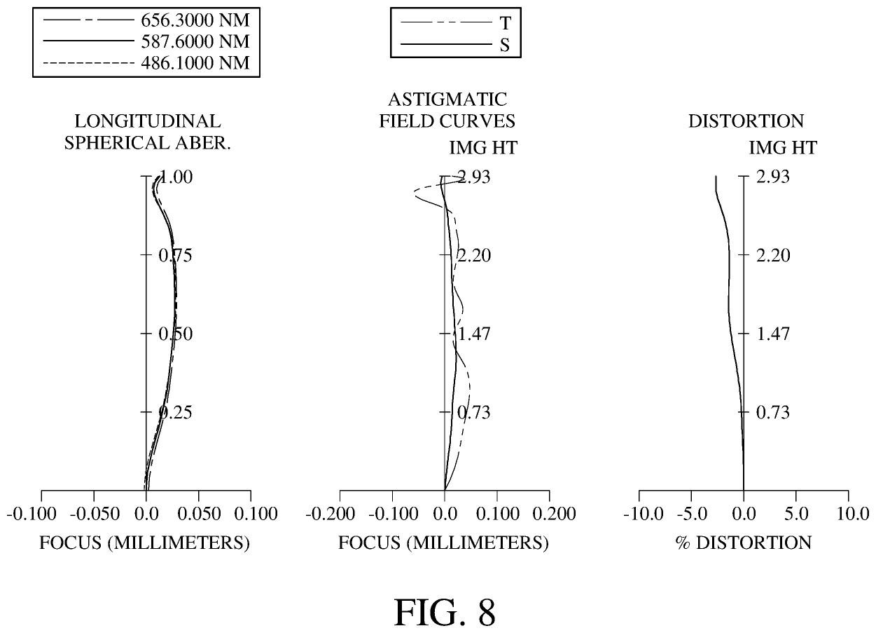

FIG. 7 is a cross-sectional view of an image capturing unit corresponding to a diagonal direction of a photosensitive area of an image sensor according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit includes the optical photographing lens assembly (its reference numeral is omitted) of the present disclosure and an image sensor 480. The optical photographing lens assembly includes, in order from an object side to an image side along an optical path, a first lens element 410, an aperture stop 400, a second lens element 420, a third lens element 430, a fourth lens element 440, a fifth lens element 450, a filter 460 and an image surface 470. The optical photographing lens assembly includes five lens elements (410, 420, 430, 440 and 450) with no additional lens element disposed between each of the adjacent five lens elements.

The first lens element 410 with negative refractive power has an object-side surface 411 being concave in a paraxial region thereof and an image-side surface 412 being concave in a paraxial region thereof. The first lens element 410 is made of plastic material and has the object-side surface 411 and the image-side surface 412 being both aspheric. The object-side surface 411 of the first lens element 410 has one critical point in an off-axis region thereof and in a maximum image height direction.

The second lens element 420 with positive refractive power has an object-side surface 421 being convex in a paraxial region thereof and an image-side surface 422 being convex in a paraxial region thereof. The second lens element 420 is made of plastic material and has the object-side surface 421 and the image-side surface 422 being both aspheric.

The third lens element 430 with negative refractive power has an object-side surface 431 being convex in a paraxial region thereof and an image-side surface 432 being concave in a paraxial region thereof. The third lens element 430 is made of plastic material and has the object-side surface 431 and the image-side surface 432 being both aspheric.

The fourth lens element 440 with positive refractive power has an object-side surface 441 being convex in a paraxial region thereof and an image-side surface 442 being convex in a paraxial region thereof. The fourth lens element 440 is made of plastic material and has the object-side surface 441 and the image-side surface 442 being both aspheric.

The fifth lens element 450 with negative refractive power has an object-side surface 451 being convex in a paraxial region thereof and an image-side surface 452 being concave in a paraxial region thereof. The fifth lens element 450 is made of plastic material and has the object-side surface 451 being aspheric and the image-side surface 452 being a freeform surface. The object-side surface 451 of the fifth lens element 450 has two critical points in an off-axis region thereof and in the maximum image height direction. The image-side surface 452 of the fifth lens element 450 has one critical point in an off-axis region thereof and in the maximum image height direction.

The filter 460 is made of glass material and located between the fifth lens element 450 and the image surface 470, and will not affect the focal length of the optical photographing lens assembly. The image sensor 480 is disposed on or near the image surface 470 of the optical photographing lens assembly.

In this embodiment, the maximum image height direction corresponds to a diagonal direction D of a photosensitive area of the image sensor 480.

In this embodiment, the image-side surface 452 of the fifth lens element 450 satisfies the following conditions: |dSAG|max=2.43 um; and |dSAG|max/CTF=7.27E-03.

The detailed optical data of the 4th embodiment are shown in Table 10, the aspheric surface data are shown in Table 11 and the freeform surface data are shown in Table 12 below.

TABLE 10
4th Embodiment
fD = 1.73 mm, fX = 1.73 mm, fY = 1.73 mm, Fno = 2.45
HFOVD = 60.0 deg., HFOVX = 53.9 deg., HFOVY = 45.6 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −2.4927 | | (ASP) | 0.618 | Plastic | 1.545 | 56.1 | −3.26 | |
| 2 | | 6.7378 | | (ASP) | 1.097 | | | | | |
| 3 | Ape. Stop | Plano | | | −0.035 | | | | | |
| 4 | Lens 2 | 2.3206 | | (ASP) | 0.854 | Plastic | 1.544 | 55.9 | 1.85 | |
| 5 | | −1.5411 | | (ASP) | 0.227 | | | | | |
| 6 | Lens 3 | 11.4707 | | (ASP) | 0.280 | Plastic | 1.686 | 18.4 | −5.94 | |
| 7 | | 2.9789 | | (ASP) | 0.421 | | | | | |
| 8 | Lens 4 | 3.5524 | | (ASP) | 0.893 | Plastic | 1.544 | 56.0 | 2.20 | |
| 9 | | −1.6468 | | (ASP) | 0.030 | | | | | |
| 10 | Lens 5 | 1.6041 | | (ASP) | 0.334 | Plastic | 1.669 | 19.5 | −2.61 | −2.61 |
| 11 | | 0.7661 | 0.7661 | (FFS) | 0.501 | | | | | |

| | | | | | | | |
|---|---|---|---|---|---|---|---|
| 12 | Filter | Plano | 0.210 | Glass | 1.517 | 64.2 | — |
| 13 | | Plano | 0.309 | | | | |
| 14 | Image | Plano | — | | | | |

Note:
Reference wavelength is 587.6 nm (d-line).

TABLE 11
Aspheric Coefficients

| Surface # | 1 | 2 | 4 | 5 | 6 |
|---|---|---|---|---|---|
| k= | 0.00000E+00 | −1.63731E+00 | 0.00000E+00 | 7.78926E−01 | 0.00000E+00 |
| A4= | 3.544997E−01 | 5.144102E−01 | −1.490725E−01 | −1.914971E−01 | −4.380798E−01 |
| A6= | −3.781391E−01 | −6.706461E−01 | 2.188311E+00 | −8.284806E−02 | 9.559503E−01 |
| A8= | 3.990181E−01 | 1.531983E+00 | −4.414427E+01 | 1.469697E+00 | −3.061981E+00 |
| A10= | −3.288203E−01 | −1.638423E−01 | 4.717446E+02 | −7.005894E+00 | 7.541145E+00 |
| A12= | 1.973882E−01 | −1.392987E+01 | −3.088569E+03 | 1.315522E+01 | −1.436159E+01 |
| A14= | −8.299840E−02 | 5.282976E+01 | 1.240849E+04 | −1.120124E+01 | 1.729490E+01 |
| A16= | 2.361303E−02 | −1.003733E+02 | −2.960345E+04 | 2.771709E+00 | −1.210253E+01 |
| A18= | −4.311689E−03 | 1.117219E+02 | 3.795658E+04 | — | 3.959319E+00 |
| A20= | 4.547277E−04 | −7.324240E+01 | −1.987276E+04 | — | — |
| A22= | −2.101965E−05 | 2.603468E+01 | — | — | — |
| A24= | — | −3.850952E+00 | — | — | — |
| Surface # | 7 | 8 | 9 | 10 | — |
| k= | 1.94725E+00 | 0.00000E+00 | −4.13754E+00 | −1.05479E+01 | — |
| A4= | −3.122086E−01 | 2.195764E−02 | 2.907242E−01 | −1.561697E−01 | — |
| A6= | 7.684803E−01 | −1.133388E−01 | −5.637653E−01 | −9.419651E−02 | — |
| A8= | −1.903167E+00 | 1.281946E−01 | 6.502476E−01 | 1.365287E−01 | — |
| A10= | 3.816249E+00 | −1.012802E−01 | −5.313673E−01 | −6.140264E−02 | — |
| A12= | −5.402367E+00 | 5.204451E−02 | 2.990998E−01 | 1.461734E−02 | — |
| A14= | 4.793163E+00 | −1.268639E−02 | −1.097100E−01 | −2.010020E−03 | — |
| A16= | −2.353668E+00 | −5.726188E−04 | 2.537874E−02 | 1.565781E−04 | — |
| A18= | 4.872208E−01 | 9.325946E−04 | −3.553225E−03 | −5.990540E−06 | — |
| A20= | — | −1.357145E−04 | 2.741743E−04 | 4.928632E−08 | — |
| A22= | — | — | −8.932435E−06 | 1.899624E−09 | — |

TABLE 12
Freeform Coefficients

| Surface # | 11 | Surface # | 11 |
|---|---|---|---|
| kx= | −3.95420E+00 | ky= | −3.95420E+00 |
| Ax4= | −2.136000E−01 | Ay4= | −2.141343E−01 |
| Ax6= | 1.593006E−01 | Ay6= | 1.593006E−01 |
| Ax8= | −1.182388E−01 | Ay8= | −1.182388E−01 |
| Ax10= | 7.597406E−02 | Ay10= | 7.597406E−02 |
| Ax12= | −3.451926E−02 | Ay12= | −3.451926E−02 |
| Ax14= | 1.046755E−02 | Ay14= | 1.046755E−02 |
| Ax16= | −2.087469E−03 | Ay16= | −2.087469E−03 |
| Ax18= | 2.666226E−04 | Ay18= | 2.666226E−04 |
| Ax20= | −2.039884E−05 | Ay20= | −2.039884E−05 |
| Ax22= | 7.785033E−07 | Ay22= | 7.785033E−07 |
| Ax24= | −4.492214E−09 | Ay24= | −4.492214E−09 |
| Ax26= | −3.947682E−10 | Ay26= | −3.947682E−10 |

In the 4th embodiment, the equations of the freeform surface profiles and the axisymmetric aspheric surface profiles of the aforementioned lens elements are the same as the equations of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 10, Table 11 and Table 12 as the following values and satisfy the following conditions:

4th Embodiment

| | | | |
|---|---|---|---|
| fD [mm] | 1.73 | T34/T23 | 1.85 |
| fX [mm] | 1.73 | TL/f | 3.33 |
| fY [mm] | 1.73 | TL/ImgH | 1.96 |
| Fno | 2.45 | (R9 + R10)/(R9 − R10) | 2.83 |
| HFOVD [deg.] | 60.0 | R1/f | −1.44 |
| HFOVX [deg.] | 53.9 | R1/f1 | 0.76 |
| HFOVY [deg.] | 45.6 | R8/f | −0.95 |
| ImgHD [mm] | 2.93 | f/f5 | −0.66 |
| ImgHX [mm] | 2.36 | f123/f | 1.80 |
| ImgHY [mm] | 1.75 | f4/CT4 | 2.47 |
| (V2 + V4)/V3 | 6.09 | f45/f | 3.06 |
| (Vi/Ni) min | 10.90 | HFOV [deg.] | 60.0 |
| V3 + V5 | 37.8 | Y52/Y11 | 1.28 |
| (CT1 + CT2 + CT4)/ | 3.85 | \|dSAG\|max [um] | 2.43 |
| (CT3 + CT5) | | | |
| (CT2 + CT3 + CT4 + | 3.82 | \|dSAG\|max/CTF | 7.27E−03 |
| CT5)/CT1 | | | |
| CT1/CT4 | 0.69 | — | — |

### 5th Embodiment

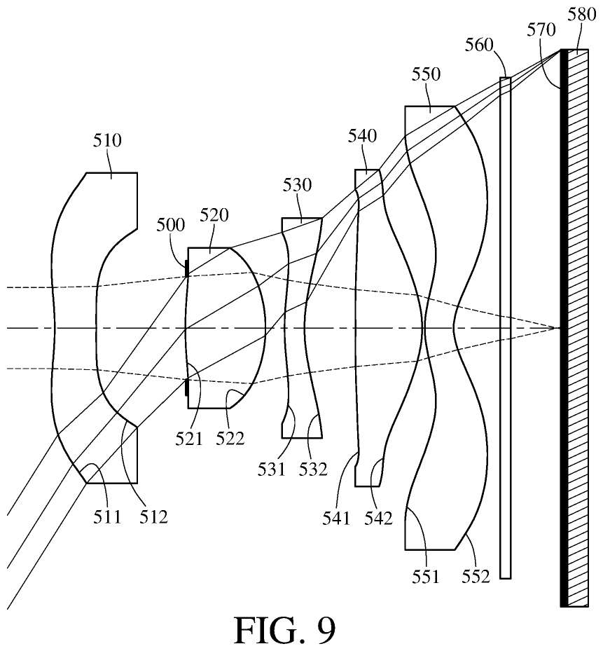

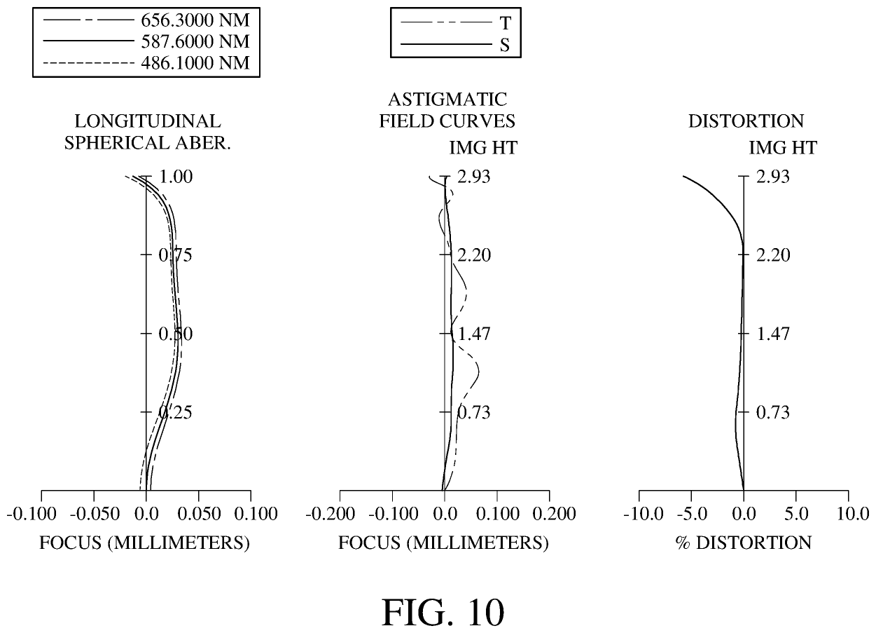

FIG. 9 is a cross-sectional view of an image capturing unit corresponding to a diagonal direction of a photosensitive area of an image sensor according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit includes the optical photographing lens assembly (its reference numeral is omitted) of the present disclosure and an image sensor 580. The optical photographing lens assembly includes, in order from an object side to an image side along an optical path, a first lens element 510, an aperture stop 500, a second lens element 520, a third lens element 530, a fourth lens element 540, a fifth lens element 550, a filter 560 and an image surface 570. The optical photographing lens assembly includes five lens elements (510, 520, 530, 540 and 550) with no additional lens element disposed between each of the adjacent five lens elements.

The first lens element 510 with negative refractive power has an object-side surface 511 being concave in a paraxial region thereof and an image-side surface 512 being convex in a paraxial region thereof. The first lens element 510 is made of plastic material and has the object-side surface 511 and the image-side surface 512 being both aspheric. The object-side surface 511 of the first lens element 510 has one critical point in an off-axis region thereof and in a maximum image height direction.

The second lens element 520 with positive refractive power has an object-side surface 521 being convex in a paraxial region thereof and an image-side surface 522 being convex in a paraxial region thereof. The second lens element 520 is made of glass material and has the object-side surface 521 and the image-side surface 522 being both aspheric.

The third lens element 530 with negative refractive power has an object-side surface 531 being convex in a paraxial region thereof and an image-side surface 532 being concave in a paraxial region thereof. The third lens element 530 is made of plastic material and has the object-side surface 531 and the image-side surface 532 being both aspheric.

The fourth lens element 540 with positive refractive power has an object-side surface 541 being concave in a paraxial region thereof and an image-side surface 542 being convex in a paraxial region thereof. The fourth lens element 540 is made of plastic material and has the object-side surface 541 and the image-side surface 542 being both aspheric.

The fifth lens element 550 with negative refractive power has an object-side surface 551 being convex in a paraxial region thereof and an image-side surface 552 being concave in a paraxial region thereof. The fifth lens element 550 is made of plastic material and has the object-side surface 551 and the image-side surface 552 being both freeform surfaces. The object-side surface 551 of the fifth lens element 550 has one critical point in an off-axis region thereof and in the maximum image height direction. The image-side surface 552 of the fifth lens element 550 has one critical point in an off-axis region thereof and in the maximum image height direction.

The filter 560 is made of glass material and located between the fifth lens element 550 and the image surface 570, and will not affect the focal length of the optical photographing lens assembly. The image sensor 580 is disposed on or near the image surface 570 of the optical photographing lens assembly.

In this embodiment, the maximum image height direction corresponds to a diagonal direction D of a photosensitive area of the image sensor 580.

In this embodiment, the object-side surface 551 of the fifth lens element 550 satisfies the following conditions: |dSAG|max=0.50 um; and |dSAG|max/CTF=1.63E-03. The image-side surface 552 of the fifth lens element 550 satisfies the following conditions: |dSAG|max=4.72 um; and |dSAG|max/CTF=1.55E-02.

The detailed optical data of the 5th embodiment are shown in Table 13, the aspheric surface data are shown in Table 14 and the freeform surface data are shown in Table 15 below.

TABLE 13
5th Embodiment
fD = 1.96 mm, fX = 1.96 mm, fY = 1.97 mm, Fno = 2.29
HFOVD = 57.8 deg., HFOVX = 50.2 deg., HFOVY = 41.5 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −2.6117 | | (ASP) | 0.437 | Plastic | 1.545 | 56.1 | −5.16 | |
| 2 | | −39.1901 | | (ASP) | 0.950 | | | | | |
| 3 | Ape. Stop | Plano | | | −0.010 | | | | | |
| 4 | Lens 2 | 3.6938 | | (ASP) | 0.845 | Glass | 1.522 | 62.2 | 2.11 | |
| 5 | | −1.4440 | | (ASP) | 0.201 | | | | | |
| 6 | Lens 3 | 2.5184 | | (ASP) | 0.210 | Plastic | 1.679 | 18.4 | −7.49 | |
| 7 | | 1.6274 | | (ASP) | 0.538 | | | | | |
| 8 | Lens 4 | −31.0126 | | (ASP) | 0.703 | Plastic | 1.544 | 56.0 | 2.02 | |
| 9 | | −1.0709 | | (ASP) | 0.028 | | | | | |
| 10 | Lens 5 | 1.0218 | 1.0192 | (FFS) | 0.304 | Plastic | 1.639 | 23.5 | −2.36 | −2.37 |
| 11 | | 0.5379 | 0.5385 | (FFS) | 0.491 | | | | | |

| | | | | | | | |
|---|---|---|---|---|---|---|---|
| 12 | Filter | Plano | 0.110 | Glass | 1.517 | 64.2 | — |
| 13 | | Plano | 0.528 | | | | |
| 14 | Image | Plano | — | | | | |

Note:
Reference wavelength is 587.6 nm (d-line).

TABLE 14
Aspheric Coefficients

| Surface # | 1 | 2 | 4 | 5 |
|---|---|---|---|---|
| k= | 0.00000E+00 | 9.90000E+01 | −1.02274E+01 | 1.91316E−01 |
| A4= | 3.753221E−01 | 5.699621E−01 | −4.868427E−02 | −1.276070E−01 |
| A6= | −3.885027E−01 | −1.924936E+00 | −6.653931E−02 | 9.160295E−02 |
| A8= | 4.707322E−01 | 1.266866E+01 | −5.504547E−01 | 3.041977E−01 |
| A10= | −5.284323E−01 | −5.496349E+01 | 7.644855E−01 | −2.570987E+00 |
| A12= | 4.794019E−01 | 1.509540E+02 | −1.058244E+00 | 4.915425E+00 |
| A14= | −3.144586E−01 | −2.667605E+02 | — | −4.230142E+00 |
| A16= | 1.391658E−01 | 3.057568E+02 | — | 1.225836E+00 |
| A18= | −3.893818E−02 | −2.237412E+02 | — | — |
| A20= | 6.177219E−03 | 9.973070E+01 | — | — |
| A22= | −4.219770E−04 | −2.438936E+01 | — | — |
| A24= | — | 2.476513E+00 | — | — |
| Surface # | 6 | | 8 | 9 |
| k= | 5.35522E−01 | −8.99042E−01 | 0.00000E+00 | −2.97568E+00 |
| A4= | −3.683840E−01 | −2.819725E−01 | 2.073319E−01 | 3.004373E−01 |
| A6= | 5.831867E−01 | 3.255215E−01 | −4.931480E−01 | −7.217323E−01 |
| A8= | −1.214822E+00 | −3.701527E−01 | 7.224755E−01 | 9.550508E−01 |
| A10= | 1.906484E+00 | 3.997090E−01 | −7.463333E−01 | −8.046116E−01 |
| A12= | −2.135826E+00 | −4.432073E−01 | 5.414727E−01 | 4.648828E−01 |
| A14= | 1.280423E+00 | 3.518085E−01 | −2.575266E−01 | −1.775893E−01 |
| A16= | −2.852201E−01 | −1.514022E−01 | 7.301606E−02 | 4.149930E−02 |
| A18= | — | 2.654649E−02 | −1.044730E−02 | −5.268304E−03 |
| A20= | — | — | 4.467766E−04 | 2.739487E−04 |

TABLE 15
Freeform Coefficients

| Surface # | 10 | 11 | Surface # | 10 | 11 |
|---|---|---|---|---|---|
| kx= | −5.53988E+00 | −3.16916E+00 | ky= | −5.47249E+00 | −3.20650E+00 |
| Ax4= | −2.659258E−01 | −3.048863E−01 | Ay4= | −2.673403E−01 | −2.977381E−01 |
| Ax6= | −2.615247E−02 | 2.785501E−01 | Ay6= | −2.629158E−02 | 2.720193E−01 |
| Ax8= | 1.705845E−01 | −2.090656E−01 | Ay8= | 1.714918E−01 | −2.041640E−01 |
| Ax10= | −1.139787E−01 | 1.253465E−01 | Ay10= | −1.145849E−01 | 1.224077E−01 |
| Ax12= | 3.524981E−02 | −5.636180E−02 | Ay12= | 3.543731E−02 | −5.504036E−02 |
| Ax14= | −4.485714E−03 | 1.809683E−02 | Ay14= | −4.509574E−03 | 1.767254E−02 |
| Ax16= | −3.055007E−04 | −4.007058E−03 | Ay16= | −3.071257E−04 | −3.913111E−03 |
| Ax18= | 1.706327E−04 | 5.878699E−04 | Ay18= | 1.715403E−04 | 5.740870E−04 |
| Ax20= | −1.995290E−05 | −5.338912E−05 | Ay20= | −2.005904E−05 | −5.213738E−05 |
| Ax22= | 7.989230E−07 | 2.580700E−06 | Ay22= | 8.031726E−07 | 2.520194E−06 |
| Ax24= | — | −3.672096E−08 | Ay24= | — | −3.586002E−08 |
| Ax26= | — | −9.904603E−10 | Ay26= | — | −9.672385E−10 |

In the 5th embodiment, the equations of the freeform surface profiles and the axisymmetric aspheric surface profiles of the aforementioned lens elements are the same as the equations of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 13, Table 14 and Table 15 as the following values and satisfy the following conditions:

5th Embodiment

| | | | |
|---|---|---|---|
| fD [mm] | 1.96 | T34/T23 | 2.68 |
| fX [mm] | 1.96 | TL/f | 2.72 |
| fY [mm] | 1.97 | TL/ImgH | 1.82 |
| Fno | 2.29 | (R9 + R10)/(R9 − R10) | 3.24 |
| HFOVD [deg.] | 57.8 | R1/f | −1.33 |
| HFOVX [deg.] | 50.2 | R1/f1 | 0.51 |
| HFOVY [deg.] | 41.5 | R8/f | −0.55 |
| ImgHD [mm] | 2.93 | f/f5 | −0.83 |
| ImgHX [mm] | 2.36 | f123/f | 1.69 |
| ImgHY [mm] | 1.75 | f4/CT4 | 2.88 |
| (V2 + V4)/V3 | 6.41 | f45/f | 2.78 |
| (Vi/Ni) min | 10.98 | HFOV [deg.] | 57.8 |
| V3 + V5 | 41.9 | Y52/Y11 | 1.43 |
| (CT1 + CT2 + CT4)/ | 3.86 | \|dSAG\|max [um] | 0.50; 4.72 |
| (CT3 + CT5) | | | |
| (CT2 + CT3 + CT4 + | 4.72 | \|dSAG\|max/CTF | 1.63E−03; |
| CT5)/CT1 | | | 1.55E−02 |
| CT1/CT4 | 0.62 | — | — |

### 6th Embodiment

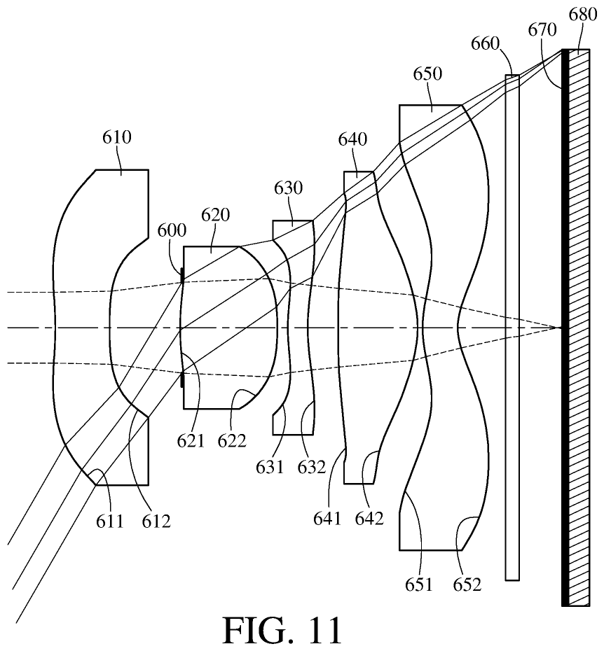

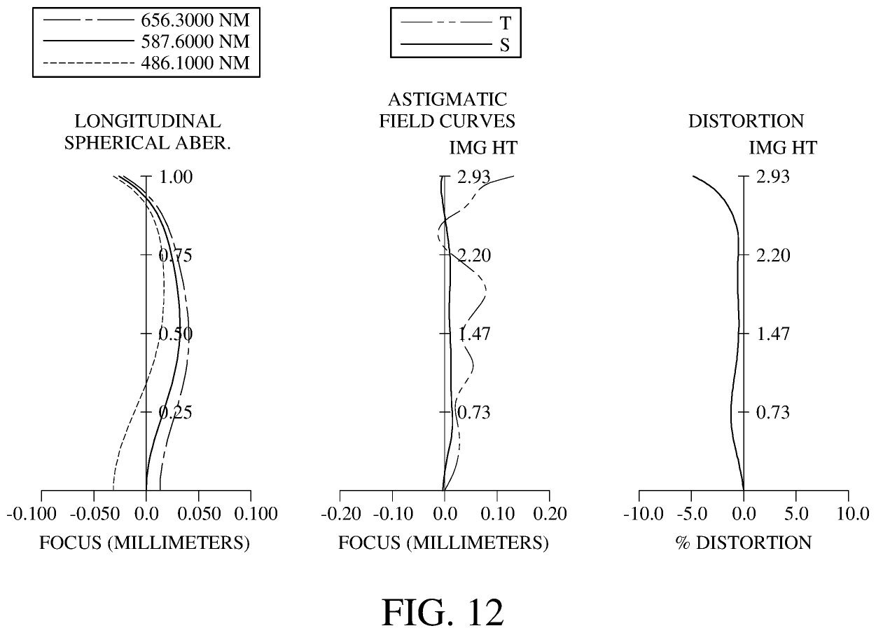

FIG. 11 is a cross-sectional view of an image capturing unit corresponding to a diagonal direction of a photosensitive area of an image sensor according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit includes the optical photographing lens assembly (its reference numeral is omitted) of the present disclosure and an image sensor 680. The optical photographing lens assembly includes, in order from an object side to an image side along an optical path, a first lens element 610, an aperture stop 600, a second lens element 620, a third lens element 630, a fourth lens element 640, a fifth lens element 650, a filter 660 and an image surface 670. The optical photographing lens assembly includes five lens elements (610, 620, 630, 640 and 650) with no additional lens element disposed between each of the adjacent five lens elements.

The first lens element 610 with negative refractive power has an object-side surface 611 being concave in a paraxial region thereof and an image-side surface 612 being concave in a paraxial region thereof. The first lens element 610 is made of plastic material and has the object-side surface 611 and the image-side surface 612 being both freeform surfaces. The object-side surface 611 of the first lens element 610 has one critical point in an off-axis region thereof and in a maximum image height direction.

The second lens element 620 with positive refractive power has an object-side surface 621 being convex in a paraxial region thereof and an image-side surface 622 being convex in a paraxial region thereof. The second lens element 620 is made of plastic material and has the object-side surface 621 and the image-side surface 622 being both aspheric.

The third lens element 630 with positive refractive power has an object-side surface 631 being convex in a paraxial region thereof and an image-side surface 632 being concave in a paraxial region thereof. The third lens element 630 is made of plastic material and has the object-side surface 631 and the image-side surface 632 being both aspheric.

The fourth lens element 640 with positive refractive power has an object-side surface 641 being concave in a paraxial region thereof and an image-side surface 642 being convex in a paraxial region thereof. The fourth lens element 640 is made of plastic material and has the object-side surface 641 and the image-side surface 642 being both aspheric.

The fifth lens element 650 with negative refractive power has an object-side surface 651 being convex in a paraxial region thereof and an image-side surface 652 being concave in a paraxial region thereof. The fifth lens element 650 is made of plastic material and has the object-side surface 651 and the image-side surface 652 being both freeform surfaces. The object-side surface 651 of the fifth lens element 650 has one critical point in an off-axis region thereof and in the maximum image height direction. The image-side surface 652 of the fifth lens element 650 has one critical point in an off-axis region thereof and in the maximum image height direction.

The filter 660 is made of glass material and located between the fifth lens element 650 and the image surface 670, and will not affect the focal length of the optical photographing lens assembly. The image sensor 695 is disposed on or near the image surface 670 of the optical photographing lens assembly.

In this embodiment, the maximum image height direction corresponds to a diagonal direction D of a photosensitive area of the image sensor 680.

In this embodiment, the object-side surface 611 of the first lens element 610 satisfies the following conditions: |dSAG|max=0.60 um; and |dSAG|max/CTF=1.04E-03. The image-side surface 612 of the first lens element 610 satisfies the following conditions: |dSAG|max=0.48 urn; and |dSAG|max/CTF=8.34E-04. The object-side surface 651 of the fifth lens element 650 satisfies the following conditions: |dSAG|max=1.92 um; and |dSAG|max/CTF=5.19E-03. The image-side surface 652 of the fifth lens element 650 satisfies the following conditions: |dSAG|max=3.64 um; and |dSAG|max/CTF=9.83E-03.

The detailed optical data of the 6th embodiment are shown in Table 16, the aspheric surface data are shown in Table 17 and the freeform surface data are shown in Table 18 below.

TABLE 16
6th Embodiment
fD = 1.76 mm, fX = 1.76 mm, fY = 1.76 mm, Fno = 2.35
HFOVD = 60.0 deg., HFOVX = 53.2 deg., HFOVY = 44.8 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −3.2390 | −3.2418 | (FFS) | 0.572 | Plastic | 1.545 | 56.1 | −3.87 | −3.87 |
| 2 | | 6.3999 | 6.4263 | (FFS) | 0.761 | | | | | |
| 3 | Ape. Stop | Plano | | | −0.017 | | | | | |
| 4 | Lens 2 | 2.9123 | | (ASP) | 1.024 | Plastic | 1.544 | 56.0 | 2.90 | |
| 5 | | −3.0057 | | (ASP) | 0.110 | | | | | |
| 6 | Lens 3 | 1.7678 | | (ASP) | 0.210 | Plastic | 1.679 | 18.4 | 11.79 | |
| 7 | | 2.1598 | | (ASP) | 0.322 | | | | | |
| 8 | Lens 4 | −37.1546 | | (ASP) | 0.837 | Plastic | 1.544 | 56.0 | 2.06 | |
| 9 | | −1.0988 | | (ASP) | 0.052 | | | | | |
| 10 | Lens 5 | 1.2188 | 1.2153 | (FFS) | 0.370 | Plastic | 1.669 | 19.5 | −2.36 | −2.37 |
| 11 | | 0.6047 | 0.6039 | (FFS) | 0.503 | | | | | |

| | | | | | | | |
|---|---|---|---|---|---|---|---|
| 12 | Filter | Plano | 0.145 | Glass | 1.517 | 64.2 | — |
| 13 | | Plano | 0.450 | | | | |
| 14 | Image | Plano | — | | | | |

Note:
Reference wavelength is 587.6 nm (d-line).

TABLE 17
Aspheric Coefficients

| Surface # | 4 | 5 | 6 |
|---|---|---|---|
| k= | −1.79449E+00 | 2.92122E+00 | −2.02168E+01 |
| A4= | −3.667368E−02 | −9.497570E−01 | −5.179238E−01 |
| A6= | −2.929026E−01 | 2.266038E+00 | 3.069720E−01 |
| A8= | 7.880423E−01 | −4.761287E+00 | 2.213953E−01 |
| A10= | −3.289009E+00 | 5.401242E+00 | −9.352031E−01 |
| A12= | 3.243497E+00 | −2.893552E+00 | 5.170242E−01 |
| A14= | — | 1.343134E−01 | −2.083082E−01 |
| A16= | — | 2.104508E−01 | 2.364709E−01 |
| Surface # | 7 | 8 | 9 |
| k= | −1.61651E+00 | 0.00000E+00 | −3.00792E+00 |
| A4= | −1.127813E−01 | 4.198403E−01 | 3.879409E−01 |
| A6= | −9.522000E−01 | −1.105394E+00 | −9.495992E−01 |
| A8= | 3.555270E+00 | 1.788292E+00 | 1.279971E+00 |
| A10= | −6.560436E+00 | −1.992334E+00 | −1.112410E+00 |
| A12= | 7.145479E+00 | 1.538192E+00 | 6.457292E−01 |
| A14= | −4.668021E+00 | −7.929365E−01 | −2.397497E−01 |
| A16= | 1.700405E+00 | 2.557512E−01 | 5.290740E−02 |
| A18= | −2.658507E−01 | −4.584922E−02 | −6.113765E−03 |
| A20= | — | 3.370164E−03 | 2.690291E−04 |

TABLE 18
Freeform Coefficients

| Surface # | 1 | 2 | Surface # | 1 | 2 |
|---|---|---|---|---|---|
| kx= | 0.00000E+00 | 2.62227E−01 | ky= | −6.04712E−07 | 2.63457E−01 |
| Ax4= | 3.392984E−01 | 6.320502E−01 | Ay4= | 3.391093E−01 | 6.327905E−01 |
| Ax6= | −3.289979E−01 | −2.578349E+00 | Ay6= | −3.288146E−01 | −2.581369E+00 |
| Ax8= | 3.247016E−01 | 2.218705E+01 | Ay8= | 3.245207E−01 | 2.221304E+01 |
| Ax10= | −2.741898E−01 | −1.223514E+02 | Ay10= | −2.740369E−01 | −1.224947E+02 |
| Ax12= | 1.873229E−01 | 4.196108E+02 | Ay12= | 1.872185E−01 | 4.201023E+02 |
| Ax14= | −9.516491E−02 | −9.184398E+02 | Ay14= | −9.511187E−02 | −9.195155E+02 |
| Ax16= | 3.345427E−02 | 1.299684E+03 | Ay16= | 3.343563E−02 | 1.301206E+03 |
| Ax18= | −7.564433E−03 | −1.173092E+03 | Ay18= | −7.560217E−03 | −1.174466E+03 |
| Ax20= | 9.853132E−04 | 6.447844E+02 | Ay20= | 9.847640E−04 | 6.455396E+02 |
| Ax22= | −5.698137E−05 | −1.943995E+02 | Ay22= | −5.694961E−05 | −1.946271E+02 |
| Ax24= | — | 2.434760E+01 | Ay24= | — | 2.437612E+01 |
| Surface # | 10 | 11 | Surface # | 10 | 11 |
| kx= | −5.44103E+00 | −3.85370E+00 | ky= | −5.41662E+00 | −3.87359E+00 |
| Ax4= | −2.956542E−01 | −2.707073E−01 | Ay4= | −2.942804E−01 | −2.721480E−01 |
| Ax6= | 5.403643E−02 | 2.824278E−01 | Ay6= | 5.378534E−02 | 2.839309E−01 |
| Ax8= | 4.400365E−02 | −2.486729E−01 | Ay8= | 4.379918E−02 | −2.499963E−01 |
| Ax10= | 8.046954E−03 | 1.715371E−01 | Ay10= | 8.009563E−03 | 1.724500E−01 |
| Ax12= | −3.706149E−02 | −8.686965E−02 | Ay12= | −3.688928E−02 | −8.733197E−02 |
| Ax14= | 2.235342E−02 | 3.140517E−02 | Ay14= | 2.224955E−02 | 3.157231E−02 |
| Ax16= | −6.566510E−03 | −8.007907E−03 | Ay16= | −6.535998E−03 | −8.050525E−03 |
| Ax18= | 1.061092E−03 | 1.419718E−03 | Ay18= | 1.056161E−03 | 1.427273E−03 |
| Ax20= | −9.026357E−05 | −1.703766E−04 | Ay20= | −8.984415E−05 | −1.712833E−04 |
| Ax22= | 3.147198E−06 | 1.314325E−05 | Ay22= | 3.132574E−06 | 1.321320E−05 |
| Ax24= | — | −5.859787E−07 | Ay24= | — | −5.890972E−07 |
| Ax26= | — | 1.143771E−08 | Ay26= | — | 1.149858E−08 |

In the 6th embodiment, the equations of the freeform surface profiles and the axisymmetric aspheric surface profiles of the aforementioned lens elements are the same as the equations of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 16, Table 17 and Table 18 as the following values and satisfy the following conditions:

6th Embodiment

| | | | |
|---|---|---|---|
| fD [mm] | 1.76 | T34/T23 | 2.93 |
| fX [mm] | 1.76 | TL/f | 3.04 |
| fY [mm] | 1.76 | TL/ImgH | 1.82 |
| Fno | 2.35 | (R9 + R10)/(R9 − R10) | 2.97 |
| HFOVD [deg.] | 60.0 | R1/f | −1.85 |
| HFOVX [deg.] | 53.2 | R1/f1 | 0.84 |
| HFOVY [deg.] | 44.8 | R8/f | −0.63 |
| ImgHD [mm] | 2.93 | f/f5 | −0.74 |
| ImgHX [mm] | 2.36 | f123/f | 1.78 |
| ImgHY [mm] | 1.75 | 14/CT4 | 2.47 |
| (V2 + V4)/V3 | 6.07 | f45/f | 3.02 |
| (Vi/Ni) min | 10.98 | HFOV [deg.] | 60.0 |
| V3 + V5 | 37.9 | Y52/Y11 | 1.41 |
| (CT1 + CT2 + CT4)/ | 4.19 | \|dSAG\|max [um] | 0.60; 0.48; |
| (CT3 + CT5) | | | 1.92; 3.64 |
| (CT2 + CT3 + CT4 + | 4.27 | \|dSAG\|max/CTF | 1.04E−03; |
| CT5)/CT1 | | | 8.34E−04; |
| | | | 5.19E−03; |
| | | | 9.83E−03 |
| CT1/CT4 | 0.68 | — | — |

### 7th Embodiment

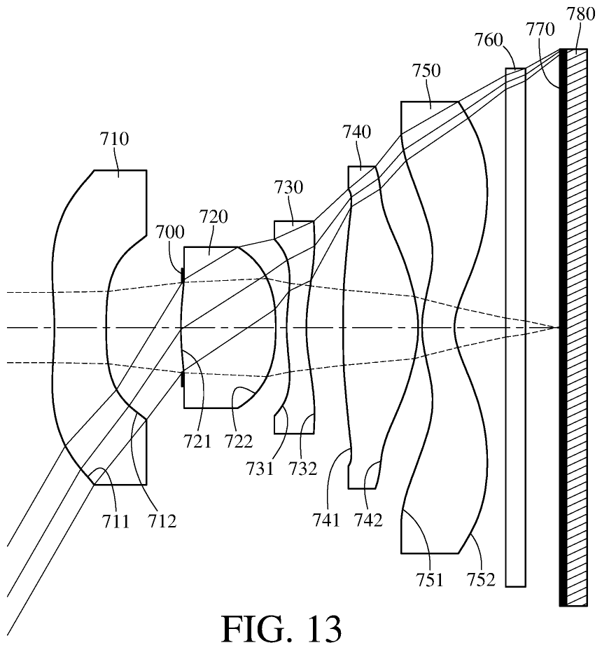

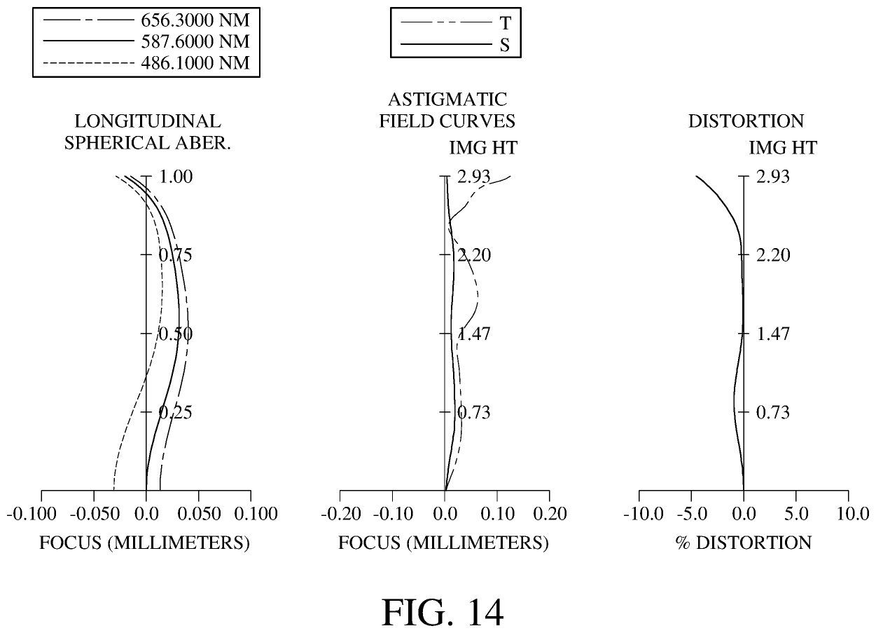

FIG. 13 is a cross-sectional view of an image capturing unit corresponding to a diagonal direction of a photosensitive area of an image sensor according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit includes the optical photographing lens assembly (its reference numeral is omitted) of the present disclosure and an image sensor 780. The optical photographing lens assembly includes, in order from an object side to an image side along an optical path, a first lens element 710, an aperture stop 700, a second lens element 720, a third lens element 730, a fourth lens element 740, a fifth lens element 750, a filter 760 and an image surface 770. The optical photographing lens assembly includes five lens elements (710, 720, 730, 740 and 750) with no additional lens element disposed between each of the adjacent five lens elements.

The first lens element 710 with negative refractive power has an object-side surface 711 being concave in a paraxial region thereof and an image-side surface 712 being concave in a paraxial region thereof. The first lens element 710 is made of plastic material and has the object-side surface 711 and the image-side surface 712 being both freeform surfaces. The object-side surface 711 of the first lens element 710 has one critical point in an off-axis region thereof and in a maximum image height direction.

The second lens element 720 with positive refractive power has an object-side surface 721 being convex in a paraxial region thereof and an image-side surface 722 being convex in a paraxial region thereof. The second lens element 720 is made of plastic material and has the object-side surface 721 and the image-side surface 722 being both aspheric.

The third lens element 730 with positive refractive power has an object-side surface 731 being convex in a paraxial region thereof and an image-side surface 732 being concave in a paraxial region thereof. The third lens element 730 is made of plastic material and has the object-side surface 731 and the image-side surface 732 being both aspheric.

The fourth lens element 740 with positive refractive power has an object-side surface 741 being convex in a paraxial region thereof and an image-side surface 742 being convex in a paraxial region thereof. The fourth lens element 740 is made of plastic material and has the object-side surface 741 and the image-side surface 742 being both aspheric.

The fifth lens element 750 with negative refractive power has an object-side surface 751 being convex in a paraxial region thereof and an image-side surface 752 being concave in a paraxial region thereof. The fifth lens element 750 is made of plastic material and has the object-side surface 751 and the image-side surface 752 being both aspheric. The object-side surface 751 of the fifth lens element 750 has one critical point in an off-axis region thereof and in the maximum image height direction. The image-side surface 752 of the fifth lens element 750 has one critical point in an off-axis region thereof and in the maximum image height direction.

The filter 760 is made of glass material and located between the fifth lens element 750 and the image surface 770, and will not affect the focal length of the optical photographing lens assembly. The image sensor 780 is disposed on or near the image surface 770 of the optical photographing lens assembly.

In this embodiment, the maximum image height direction corresponds to a diagonal direction D of a photosensitive area of the image sensor 780.

In this embodiment, the object-side surface 711 of the first lens element 710 satisfies the following conditions: |dSAG|max=0.67 um; and |dSAG|max/CTF=1.22E-03. The image-side surface 712 of the first lens element 710 satisfies the following conditions: |dSAG|max=0.77 um; and |dSAG|max/CTF=1.40E-03.

The detailed optical data of the 7th embodiment are shown in Table 19, the aspheric surface data are shown in Table 20 and the freeform surface data are shown in Table 21 below.

TABLE 19
7th Embodiment
fD = 1.77 mm, fX = 1.77 mm, fY = 1.77 mm, Fno = 2.37
HFOVD = 60.0 deg., HFOVX = 53.1 deg., HFOVY = 44.5 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −3.3504 | −3.3469 | (FFS) | 0.550 | Plastic | 1.545 | 56.1 | −3.92 | −3.91 |
| 2 | | 6.2523 | 6.2190 | (FFS) | 0.807 | | | | | |
| 3 | Ape. Stop | Plano | | | −0.013 | | | | | |
| 4 | Lens 2 | 3.1254 | | (ASP) | 1.008 | Plastic | 1.544 | 56.0 | 2.74 | |
| 5 | | −2.5334 | | (ASP) | 0.115 | | | | | |
| 6 | Lens 3 | 1.7586 | | (ASP) | 0.210 | Plastic | 1.686 | 18.4 | 16.48 | |
| 7 | | 1.9812 | | (ASP) | 0.391 | | | | | |
| 8 | Lens 4 | 111.0982 | | (ASP) | 0.797 | Plastic | 1.544 | 56.0 | 2.21 | |
| 9 | | −1.2150 | | (ASP) | 0.041 | | | | | |
| 10 | Lens 5 | 1.0855 | | (ASP) | 0.344 | Plastic | 1.669 | 19.5 | −2.58 | |
| 11 | | 0.5818 | | (ASP) | 0.545 | | | | | |

| | | | | | | | |
|---|---|---|---|---|---|---|---|
| 12 | Filter | Plano | 0.210 | Glass | 1.517 | 64.2 | — |
| 13 | | Plano | 0.364 | | | | |
| 14 | Image | Plano | — | | | | |

Note:
Reference wavelength is 587.6 nm (d-line).

TABLE 20
Aspheric Coefficients

| Surface # | 4 | 5 | 6 | 7 |
|---|---|---|---|---|
| k= | −8.90474E+00 | 2.12164E+00 | −1.22783E+01 | −1.46285E+00 |
| A4= | −3.400840E−02 | −8.070886E−01 | −6.006626E−01 | −1.787146E−01 |
| A6= | −1.977790E−01 | 1.669408E+00 | 1.213336E+00 | −3.395621E−01 |
| A8= | −6.516948E−02 | −3.170313E+00 | −3.847671E+00 | 1.240727E+00 |
| A10= | −5.420333E−01 | 2.942922E+00 | 8.721966E+00 | −1.887365E+00 |
| A12= | −3.693910E−02 | −7.089547E−01 | −1.228330E+01 | 1.574488E+00 |
| A14= | — | −8.907479E−01 | 8.968838E+00 | −7.198113E−01 |
| A16= | — | 4.018270E−01 | −2.532072E+00 | 1.600667E−01 |
| A18= | — | — | — | −1.073377E−02 |
| Surface # | 8 | 9 | 10 | 11 |
| k= | 0.00000E+00 | −2.84290E+00 | −5.42960E+00 | −3.56687E+00 |
| A4= | 2.908436E−01 | 3.640175E−01 | −2.707182E−01 | −2.837953E−01 |
| A6= | −7.068783E−01 | −8.598820E−01 | 1.548704E−02 | 2.913627E−01 |
| A8= | 1.017378E+00 | 1.110561E+00 | 9.153551E−02 | −2.411785E−01 |
| A10= | −9.907189E−01 | −9.280479E−01 | −3.898111E−02 | 1.541401E−01 |
| A12= | 6.731674E−01 | 5.311251E−01 | −6.268229E−03 | −7.256439E−02 |
| A14= | −3.102320E−01 | −1.995056E−01 | 9.760303E−03 | 2.448857E−02 |
| A16= | 9.086540E−02 | 4.551198E−02 | −3.389450E−03 | −5.834637E−03 |
| A18= | −1.505522E−02 | −5.585180E−03 | 5.815054E−04 | 9.651628E−04 |
| A20= | 1.037014E−03 | 2.755482E−04 | −5.068046E−05 | −1.078281E−04 |
| A22= | — | — | 1.780658E−06 | 7.734380E−06 |
| A24= | — | — | — | −3.213099E−07 |
| A26= | — | — | — | 5.893861E−09 |

TABLE 21
Freeform Coefficients

| Surface # | 1 | 2 | Surface # | 1 | 2 |
|---|---|---|---|---|---|
| kx= | 0.00000E+00 | 2.26662E+01 | ky= | −8.68665E−07 | 2.25300E+01 |
| Ax4= | 3.164081E−01 | 4.441002E−01 | Ay4= | 3.165979E−01 | 4.436628E−01 |
| Ax6= | −2.718875E−01 | −4.160441E−01 | Ay6= | −2.720506E−01 | −4.156344E−01 |
| Ax8= | 2.403377E−01 | 3.961233E+00 | Ay8= | 2.404819E−01 | 3.957331E+00 |
| Ax10= | −1.952757E−01 | −2.496569E+01 | Ay10= | −1.953928E−01 | −2.494110E+01 |
| Ax12= | 1.409030E−01 | 8.351660E+01 | Ay12= | 1.409875E−01 | 8.343434E+01 |
| Ax14= | −7.944048E−02 | −1.565976E+02 | Ay14= | −7.948813E−02 | −1.564433E+02 |
| Ax16= | 3.135748E−02 | 1.599240E+02 | Ay16= | 3.137629E−02 | 1.597665E+02 |
| Ax18= | −7.938500E−03 | −6.458571E+01 | Ay18= | −7.943261E−03 | −6.452209E+01 |
| Ax20= | 1.148276E−03 | −2.579676E+01 | Ay20= | 1.148964E−03 | −2.577135E+01 |
| Ax22= | −7.256498E−05 | 3.374000E+01 | Ay22= | −7.260850E−05 | 3.370676E+01 |
| Ax24= | — | −8.873807E+00 | Ay24= | — | −8.865067E+00 |

In the 7th embodiment, the equations of the freeform surface profiles and the axisymmetric aspheric surface profiles of the aforementioned lens elements are the same as the equations of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 19, Table 20 and Table 21 as the following values and satisfy the following conditions:

7th Embodiment

| | | | |
|---|---|---|---|
| fD [mm] | 1.77 | T34/T23 | 3.40 |
| fX [mm] | 1.77 | TL/f | 3.04 |
| fY [mm] | 1.77 | TL/ImgH | 1.83 |
| Fno | 2.37 | (R9 + R10)/(R9 − R10) | 3.31 |
| HFOVD [deg.] | 60.0 | R1/f | −1.89 |
| HFOVX [deg.] | 53.1 | R1/f1 | 0.85 |
| HFOVY [deg.] | 44.5 | R8/f | −0.69 |
| ImgHD [mm] | 2.93 | f/f5 | −0.68 |
| ImgHX [mm] | 2.36 | f 123/f | 1.73 |
| ImgHY [mm] | 1.75 | f4/CT4 | 2.78 |
| (V2 + V4)/V3 | 6.09 | f45/f | 3.16 |
| (Vi/Ni) min | 10.90 | HFOV [deg.] | 60.0 |
| V3 + V5 | 37.8 | Y52/Y11 | 1.44 |
| (CT1 + CT2 + CT4)/ | 4.25 | \|dSAG\|max [um] | 0.67; 0.77 |
| (CT3 + CT5) | | | |
| (CT2 + CT3 + CT4 + | 4.29 | \|dSAG\|max/CTF | 1.22E−03; |
| CT5)/CT1 | | | 1.40E−03 |
| CT1/CT4 | 0.69 | — | — |

### 8th Embodiment

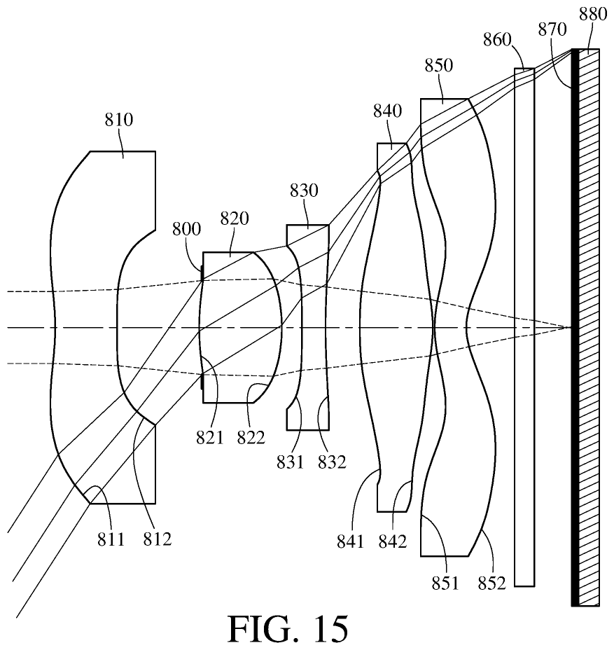

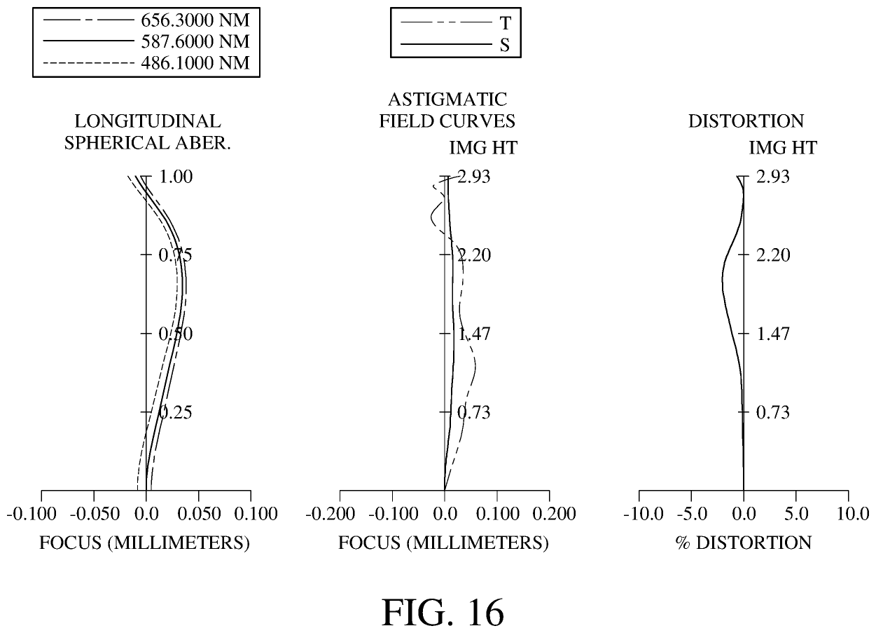

FIG. 15 is a cross-sectional view of an image capturing unit corresponding to a diagonal direction of a photosensitive area of an image sensor according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit includes the optical photographing lens assembly (its reference numeral is omitted) of the present disclosure and an image sensor 880. The optical photographing lens assembly includes, in order from an object side to an image side along an optical path, a first lens element 810, an aperture stop 800, a second lens element 820, a third lens element 830, a fourth lens element 840, a fifth lens element 850, a filter 860 and an image surface 870. The optical photographing lens assembly includes five lens elements (810, 820, 830, 840 and 850) with no additional lens element disposed between each of the adjacent five lens elements.

The first lens element 810 with negative refractive power has an object-side surface 811 being concave in a paraxial region thereof and an image-side surface 812 being convex in a paraxial region thereof. The first lens element 810 is made of plastic material and has the object-side surface 811 being a freeform surface and the image-side surface 812 being aspheric. The object-side surface 811 of the first lens element 810 has one critical point in an off-axis region thereof and in a maximum image height direction.

The second lens element 820 with positive refractive power has an object-side surface 821 being convex in a paraxial region thereof and an image-side surface 822 being convex in a paraxial region thereof. The second lens element 820 is made of plastic material and has the object-side surface 821 and the image-side surface 822 being both aspheric.

The third lens element 830 with negative refractive power has an object-side surface 831 being concave in a paraxial region thereof and an image-side surface 832 being concave in a paraxial region thereof. The third lens element 830 is made of plastic material and has the object-side surface 831 and the image-side surface 832 being both aspheric.

The fourth lens element 840 with positive refractive power has an object-side surface 841 being convex in a paraxial region thereof and an image-side surface 842 being convex in a paraxial region thereof. The fourth lens element 840 is made of plastic material and has the object-side surface 841 and the image-side surface 842 being both aspheric.

The fifth lens element 850 with negative refractive power has an object-side surface 851 being convex in a paraxial region thereof and an image-side surface 852 being concave in a paraxial region thereof. The fifth lens element 850 is made of plastic material and has the object-side surface 851 and the image-side surface 852 being both aspheric. The object-side surface 851 of the fifth lens element 850 has two critical points in an off-axis region thereof and in the maximum image height direction. The image-side surface 852 of the fifth lens element 850 has one critical point in an off-axis region thereof and in the maximum image height direction.

The filter 860 is made of glass material and located between the fifth lens element 850 and the image surface 870, and will not affect the focal length of the optical photographing lens assembly. The image sensor 880 is disposed on or near the image surface 870 of the optical photographing lens assembly.

In this embodiment, the maximum image height direction corresponds to a diagonal direction D of a photosensitive area of the image sensor 880.

In this embodiment, the object-side surface 811 of the first lens element 810 satisfies the following conditions: |dSAG|max=0.92 um; and |dSAG|max/CTF=1.41 E-03.

The detailed optical data of the 8th embodiment are shown in Table 22, the aspheric surface data are shown in Table 23 and the freeform surface data are shown in Table 24 below.

TABLE 22
8th Embodiment
fD = 1.89 mm, fX = 1.89 mm, fY = 1.89 mm, Fno = 2.49
HFOVD = 57.2 deg., HFOVX = 51.2 deg., HFOVY = 43.0 deg.
ImgHD = 2.93 mm, ImgHX = 2.36 mm, ImgHY = 1.75 mm

| | | Curvature Radius | | | | | | | Focal Length | |
|---|---|---|---|---|---|---|---|---|---|---|
| Surface # | | (Y-dir.) | (X-dir.) | | Thickness | Material | Index | Abbe # | (Y-dir.) | (X-dir.) |
| 0 | Object | Plano | | | Infinity | | | | | |
| 1 | Lens 1 | −2.4599 | −2.4622 | (FFS) | 0.655 | Plastic | 1.529 | 58.0 | −4.71 | −4.72 |
| 2 | | −200.0000 | | (ASP) | 0.900 | | | | | |
| 3 | Ape. Stop | Plano | | | −0.030 | | | | | |
| 4 | Lens 2 | 2.6932 | | (ASP) | 0.874 | Plastic | 1.562 | 44.6 | 2.08 | |
| 5 | | −1.8190 | | (ASP) | 0.213 | | | | | |
| 6 | Lens 3 | −200.0000 | | (ASP) | 0.250 | Plastic | 1.701 | 14.8 | −7.90 | |
| 7 | | 5.6999 | | (ASP) | 0.363 | | | | | |
| 8 | Lens 4 | 4.8299 | | (ASP) | 0.773 | Plastic | 1.529 | 58.0 | 2.21 | |
| 9 | | −1.4531 | | (ASP) | 0.020 | | | | | |
| 10 | Lens 5 | 1.2388 | | (ASP) | 0.334 | Plastic | 1.669 | 19.5 | −2.46 | |
| 11 | | 0.6307 | | (ASP) | 0.511 | | | | | |

| | | | | | | | |
|---|---|---|---|---|---|---|---|
| 12 | Filter | Plano | 0.210 | Glass | 1.517 | 64.2 | — |
| 13 | | Plano | 0.397 | | | | |
| 14 | Image | Plano | — | | | | |

Note:
Reference wavelength is 587.6 nm (d-line).

TABLE 23
Aspheric Coefficients

| Surface # | 2 | 4 | 5 | 6 | 7 |
|---|---|---|---|---|---|
| k= | 9.90000E+01 | 0.00000E+00 | 2.53398E−01 | −9.90000E+01 | 7.48817E+00 |
| A4= | 4.648345E−01 | −9.304066E−02 | −2.461612E−01 | −3.638513E−01 | −1.906423E−01 |
| A6= | −5.302735E−01 | 1.493272E+00 | 5.678366E−01 | 8.772600E−01 | 3.572417E−01 |
| A8= | 6.238317E−01 | −3.108028E+01 | −2.510941E+00 | −1.468467E+00 | −1.720837E−01 |
| A10= | 3.911197E+00 | 3.519352E+02 | 5.357138E+00 | −1.854609E−01 | −5.108095E−01 |
| A12= | −2.798571E+01 | −2.485256E+03 | −7.984179E+00 | 3.478371E+00 | 9.489200E−01 |
| A14= | 8.676022E+01 | 1.088275E+04 | 7.276800E+00 | −5.117859E+00 | −7.292914E−01 |
| A16= | −1.545439E+02 | −2.856701E+04 | −3.255665E+00 | 2.479149E+00 | 2.858036E−01 |
| A18= | 1.669491E+02 | 4.075735E+04 | — | — | −4.732189E−02 |
| A20= | −1.074984E+02 | −2.404562E+04 | — | — | — |
| A22= | 3.774452E+01 | — | — | — | — |
| A24= | −5.536324E+00 | — | — | — | — |
| Surface # | 8 | 9 | 10 | 11 | — |
| k= | 0.00000E+00 | −9.34502E+00 | −7.57345E+00 | −4.02670E+00 | — |
| A4= | 2.166773E−01 | 3.878815E−01 | −1.176440E−01 | −2.006742E−01 | — |
| A6= | −4.467608E−01 | −5.755821E−01 | −9.573180E−02 | 1.715284E−01 | — |
| A8= | 4.842987E−01 | 4.722054E−01 | 8.925726E−02 | −1.746883E−01 | — |
| A10= | −3.532668E−01 | −2.798040E−01 | −1.889275E−02 | 1.476445E−01 | — |
| A12= | 1.764496E−01 | 1.271686E−01 | −3.623223E−03 | −8.648609E−02 | — |
| A14= | −5.773122E−02 | −4.151107E−02 | 2.610406E−03 | 3.441112E−02 | — |
| A16= | 1.118832E−02 | 9.034741E−03 | −5.727229E−04 | −9.333916E−03 | — |
| A18= | −1.014863E−03 | −1.230768E−03 | 6.459343E−05 | 1.719432E−03 | — |
| A20= | 1.181830E−05 | 9.499572E−05 | −3.775073E−06 | −2.109000E−04 | — |
| A22= | — | −3.181332E−06 | 9.039513E−08 | 1.643633E−05 | — |
| A24= | — | — | — | −7.341567E−07 | — |
| A26= | — | — | — | 1.426450E−08 | — |

TABLE 24
Freeform Coefficients

| Surface # | 1 | Surface # | 1 |
|---|---|---|---|
| kx= | 0.00000E+00 | ky= | −6.67649E−07 |
| Ax4= | 3.180910E−01 | Ay4= | 3.179380E−01 |
| Ax6= | −3.148118E−01 | Ay6= | −3.146603E−01 |
| Ax8= | 3.258397E−01 | Ay8= | 3.256829E−01 |
| Ax10= | −2.724487E−01 | Ay10= | −2.723177E−01 |
| Ax12= | 1.704985E−01 | Ay12= | 1.704165E−01 |
| Ax14= | −7.582088E−02 | Ay14= | −7.578439E−02 |
| Ax16= | 2.298780E−02 | Ay16= | 2.297674E−02 |
| Ax18= | −4.491561E−03 | Ay18= | −4.489399E−03 |
| Ax20= | 5.084768E−04 | Ay20= | 5.082322E−04 |
| Ax22= | −2.534988E−05 | Ay22= | −2.533768E−05 |

In the 8th embodiment, the equations of the freeform surface profiles and the axisymmetric aspheric surface profiles of the aforementioned lens elements are the same as the equations of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from Table 22, Table 23 and Table 24 as the following values and satisfy the following conditions:

8th Embodiment

| | | | |
|---|---|---|---|
| fD [mm] | 1.89 | T34/T23 | 1.70 |
| fX [mm] | 1.89 | TL/f | 2.89 |
| fY [mm] | 1.89 | TL/ImgH | 1.86 |
| Fno | 2.49 | (R9 + R10)/(R9 − R10) | 3.07 |
| HFOVD [deg.] | 57.2 | R1/f | −1.30 |
| HFOVX [deg.] | 51.2 | R1/f1 | 0.52 |
| HFOVY [deg.] | 43.0 | R8/f | −0.77 |
| ImgHD [mm] | 2.93 | f/f5 | −0.77 |
| ImgHX [mm] | 2.36 | f123/f | 1.75 |
| ImgHY [mm] | 1.75 | f4/CT4 | 2.85 |
| (V2 + V4)/V3 | 6.93 | f45/f | 3.11 |
| (Vi/Ni) min | 8.70 | HFOV [deg.] | 57.2 |
| V3 + V5 | 34.3 | Y52/Y11 | 1.30 |
| (CT1 + CT2 + CT4)/ | 3.94 | \|dSAG\|max [um] | 0.92 |
| (CT3 + CT5) | | | |
| (CT2 + CT3 + CT4 + | 3.41 | \|dSAG\|max/CTF | 1.41E−03 |
| CT5)/CT1 | | | |
| CT1/CT4 | 0.85 | — | — |

### 9th Embodiment

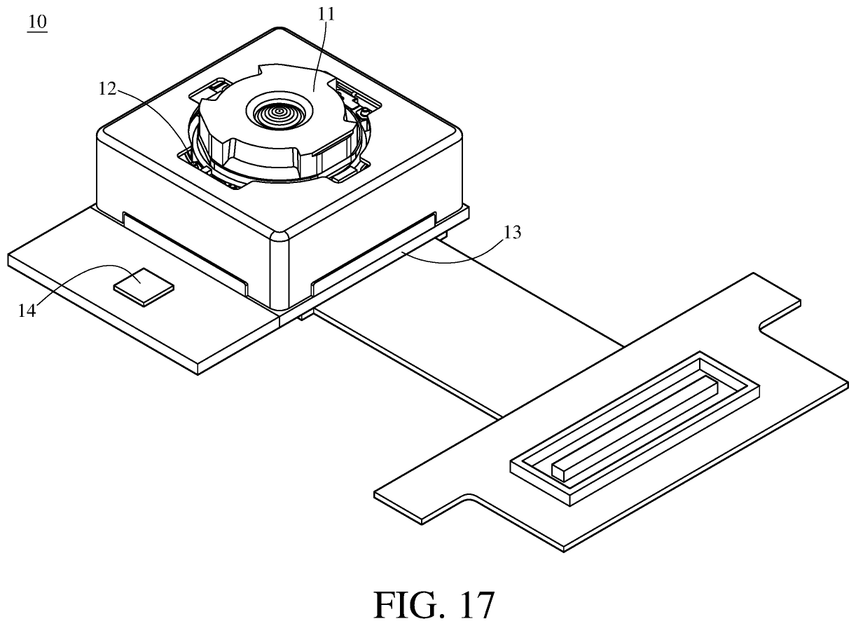

FIG. 17 is a perspective view of an image capturing unit according to the 9th embodiment of the present disclosure. In this embodiment, an image capturing unit is a camera module including a lens unit 11, a driving device 12, an image sensor 13 and an image stabilizer 14. The lens unit 11 includes the optical photographing lens assembly disclosed in the 1st embodiment, a barrel and a holder member (their reference numerals are omitted) for holding the optical photographing lens assembly. However, the lens unit 11 may alternatively be provided with the optical photographing lens assembly disclosed in other embodiments of the present disclosure, and the present disclosure is not limited thereto. The imaging light converges in the lens unit 11 of the image capturing unit to generate an image with the driving device 12 utilized for image focusing on the image sensor 13, and the generated image is then digitally transmitted to other electronic component for further processing.

The driving device 12 can have auto focusing functionality, and different driving configurations can be obtained through the usages of voice coil motors (VCM), micro electro-mechanical systems (MEMS), piezoelectric systems, or shape memory alloy materials. The driving device 12 is favorable for obtaining a better imaging position of the lens unit 11, so that a clear image of the imaged object can be captured by the lens unit 11 with different object distances. The image sensor 13 (for example, CCD or CMOS), which can feature high photosensitivity and low noise, is disposed on the image surface of the optical photographing lens assembly to provide higher image quality.

The image stabilizer 14, such as an accelerometer, a gyro sensor and a Hall Effect sensor, is configured to work with the driving device 12 to provide optical image stabilization (OIS). The driving device 12 working with the image stabilizer 14 is favorable for compensating for pan and tilt of the lens unit 11 to reduce blurring associated with motion during exposure. In some cases, the compensation can be provided by electronic image stabilization (EIS) with image processing software, thereby improving image quality while in motion or low-light conditions.

### 10th Embodiment

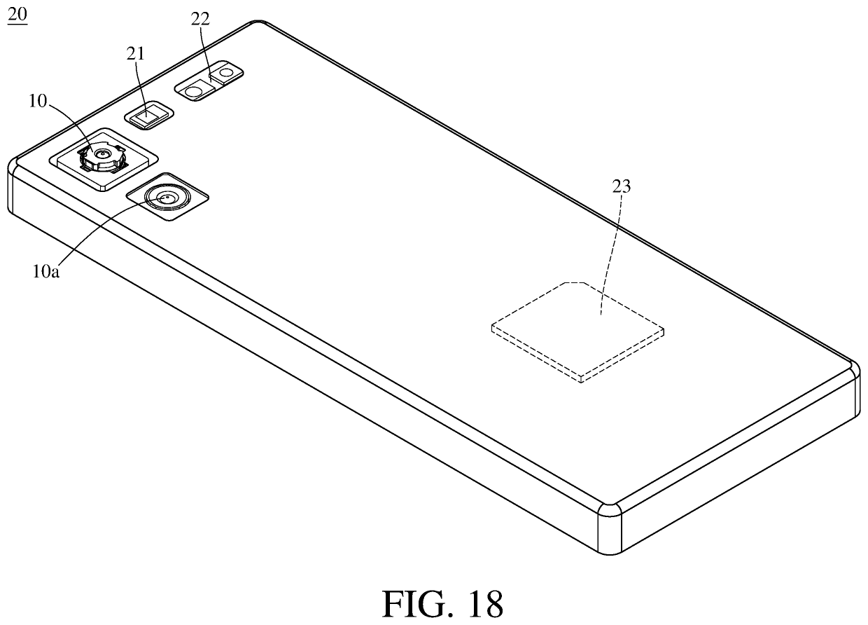

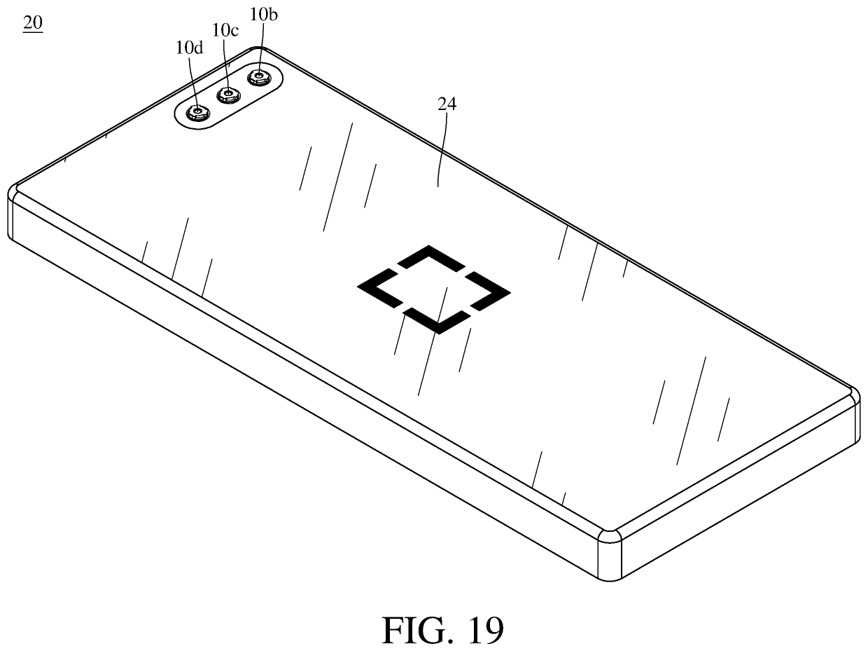

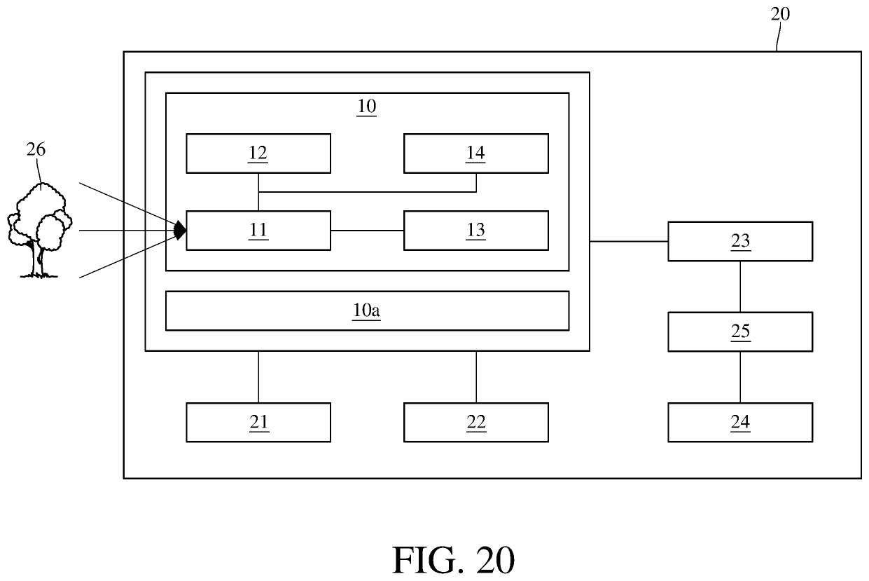

FIG. 18 is one perspective view of an electronic device according to the 10th embodiment of the present disclosure. FIG. 19 is another perspective view of the electronic device in FIG. 18. FIG. 20 is a block diagram of the electronic device in FIG. 18.

In this embodiment, an electronic device 20 is a smartphone including the image capturing unit 10 disclosed in the 9th embodiment, an image capturing unit 10a, an image capturing unit 10b, an image capturing unit 10c, an image capturing unit 10d, a flash module 21, a focus assist module 22, an image signal processor 23, a display module 24 and an image software processor 25. The image capturing unit 10 and the image capturing unit 10a are disposed on the same side of the electronic device 20 and each of the image capturing units 10 and 10a has a single focal point. The image capturing unit 10b, the image capturing unit 10c, the image capturing unit 10d and the display module 24 are disposed on the opposite side of the electronic device 20, and the display module 24 can be a user interface, such that the image capturing units 10b, 10c, 10d can be front-facing cameras of the electronic device 20 for taking selfies, but the present disclosure is not limited thereto. Furthermore, each of the image capturing units 10a, 10b, 10c and 10d can include the optical photographing lens assembly of the present disclosure and can have a configuration similar to that of the image capturing unit 10. In detail, each of the image capturing units 10a, 10b, 10c and 10d can include a lens unit, a driving device, an image sensor and an image stabilizer, and each of the lens unit can include an optical lens assembly such as the optical photographing lens assembly of the present disclosure, a barrel and a holder member for holding the optical lens assembly.

The image capturing unit 10 is a wide-angle image capturing unit, the image capturing unit 10a is an ultra-wide-angle image capturing unit, the image capturing unit 10b is a wide-angle image capturing unit, the image capturing unit 10c is an ultra-wide-angle image capturing unit, and the image capturing unit 10d is a ToF (time of flight) image capturing unit. In this embodiment, the image capturing units 10, 10a, 10b and 10c have different fields of view, such that the electronic device can have various magnification ratios so as to meet the requirement of optical zoom functionality. In addition, the image capturing unit 10d can determine depth information of the imaged object. In this embodiment, the electronic device 20 includes multiple image capturing units 10, 10a, 10b, 10c and 10d, but the present disclosure is not limited to the number and arrangement of image capturing units.

When a user captures images of an object 26, the light rays converge in the image capturing unit 10 or the image capturing unit 10a to generate images, and the flash module 21 is activated for light supplement. The focus assist module 22 detects the object distance of the imaged object 26 to achieve fast auto focusing.

The image signal processor 23 is configured to optimize the captured image to improve image quality. The light beam emitted from the focus assist module 22 can be either conventional infrared or laser. In addition, the light rays may converge in the image capturing unit 10b, 10c or 10d to generate images. The display module 24 can include a touch screen, and the user is able to interact with the display module 24 and the image software processor 25 having multiple functions to capture images and complete image processing. Alternatively, the user may capture images via a physical button. The image processed by the image software processor 25 can be displayed on the display module 24.

### 11th Embodiment

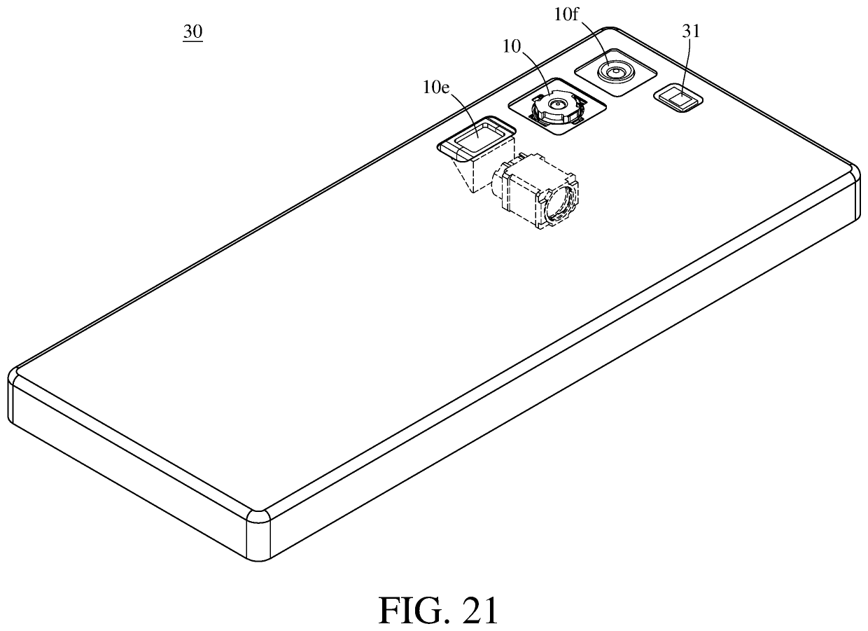

FIG. 21 is one perspective view of an electronic device according to the 11th embodiment of the present disclosure.

In this embodiment, an electronic device 30 is a smartphone including the image capturing unit 10 disclosed in the 9th embodiment, an image capturing unit 10e, an image capturing unit 10f, a flash module 31, a focus assist module, an image signal processor, a display module and an image software processor (not shown). The image capturing unit 10, the image capturing unit 10e and the image capturing unit 10f are disposed on the same side of the electronic device 30, while the display module is disposed on the opposite side of the electronic device 30. Furthermore, each of the image capturing units 10e and 10f can include the optical photographing lens assembly of the present disclosure and can have a configuration similar to that of the image capturing unit 10, and the details in this regard will not be provided again.

The image capturing unit 10 is a wide-angle image capturing unit, the image capturing unit 10e is a telephoto image capturing unit, and the image capturing unit 10f is an ultra-wide-angle image capturing unit. In this embodiment, the image capturing units 10, 10e and 10f have different fields of view, such that the electronic device 30 can have various magnification ratios so as to meet the requirement of optical zoom functionality. Moreover, the image capturing unit 10e can be a telephoto image capturing unit having a light-folding element configuration, such that the total track length of the image capturing unit 10e is not limited by the thickness of the electronic device 30. Moreover, the light-folding element configuration of the image capturing unit 10e can be similar to, for example, one of the structures shown in FIG. 30 to FIG. 32, which can be referred to foregoing descriptions corresponding to FIG. 30 to FIG. 32, and the details in this regard will not be provided again. In this embodiment, the electronic device 30 includes multiple image capturing units 10, 10e and 10f, but the present disclosure is not limited to the number and arrangement of image capturing units. When a user captures images of an object, light rays converge in the image capturing unit 10, 10e or 10f to generate images, and the flash module 31 is activated for light supplement. Further, the subsequent processes are performed in a manner similar to the abovementioned embodiment, so the details in this regard will not be provided again.

### 12th Embodiment

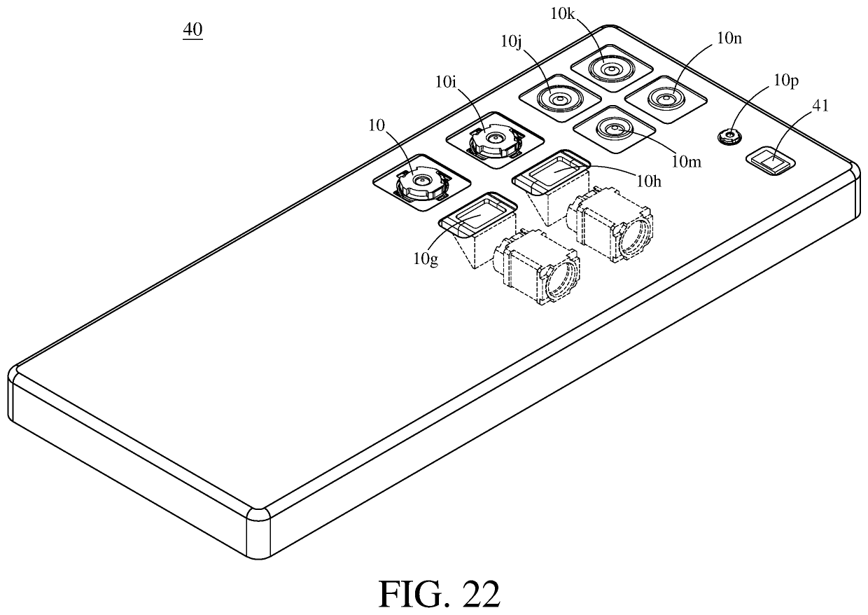

FIG. 22 is one perspective view of an electronic device according to the 12th embodiment of the present disclosure.

In this embodiment, an electronic device 40 is a smartphone including the image capturing unit 10 disclosed in the 9th embodiment, an image capturing unit 10g, an image capturing unit 10h, an image capturing unit 10i, an image capturing unit 10j, an image capturing unit 10k, an image capturing unit 10m, an image capturing unit 10n, an image capturing unit 10p, a flash module 41, a focus assist module, an image signal processor, a display module and an image software processor (not shown). The image capturing units 10, 10g, 10h, 10i, 10j, 10k, 10m, 10n and 10p are disposed on the same side of the electronic device 40, while the display module is disposed on the opposite side of the electronic device 40.

Furthermore, each of the image capturing units 10g, 10h, 10i, 10j, 10k, 10m, 10n and 10p can include the optical photographing lens assembly of the present disclosure and can have a configuration similar to that of the image capturing unit 10, and the details in this regard will not be provided again.

The image capturing unit 10 is a wide-angle image capturing unit, the image capturing unit 10g is a telephoto image capturing unit, the image capturing unit 10h is a telephoto image capturing unit, the image capturing unit 10i is a wide-angle image capturing unit, the image capturing unit 10j is an ultra-wide-angle image capturing unit, the image capturing unit 10k is an ultra-wide-angle image capturing unit, the image capturing unit 10m is a telephoto image capturing unit, the image capturing unit 10n is a telephoto image capturing unit, and the image capturing unit 10p is a ToF image capturing unit. In this embodiment, the image capturing units 10, 10g, 10h, 10i, 10j, 10k, 10m and 10n have different fields of view, such that the electronic device 40 can have various magnification ratios so as to meet the requirement of optical zoom functionality. Moreover, each of the image capturing units 10g and 10h can be a telephoto image capturing unit having a light-folding element configuration. Moreover, the light-folding element configuration of each of the image capturing unit 10g and 10h can be similar to, for example, one of the structures shown in FIG. 30 to FIG. 32, which can be referred to foregoing descriptions corresponding to FIG. 30 to FIG. 32, and the details in this regard will not be provided again. In addition, the image capturing unit 10p can determine depth information of the imaged object. In this embodiment, the electronic device 40 includes multiple image capturing units 10, 10g, 10h, 10i, 10j, 10k, 10m, 10n and 10p, but the present disclosure is not limited to the number and arrangement of image capturing units. When a user captures images of an object, the light rays converge in the image capturing unit 10, 10g, 10h, 10i, 10j, 10k, 10m, 10n or 10p to generate images, and the flash module 41 is activated for light supplement. Further, the subsequent processes are performed in a manner similar to the abovementioned embodiments, and the details in this regard will not be provided again.

The smartphone in this embodiment is only exemplary for showing the image capturing unit 10 of the present disclosure installed in an electronic device, and the present disclosure is not limited thereto. The image capturing unit 10 can be optionally applied to optical systems with a movable focus. Furthermore, the optical photographing lens assembly of the image capturing unit 10 features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1-24 show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical photographing lens assembly comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the first lens element has negative refractive power, the object-side surface of the first lens element is concave in a paraxial region thereof, the five lens elements comprise at least one freeform lens element, and at least one of the object-side surface and the image-side surface of the at least one freeform lens element is a freeform surface;
wherein a paraxial curvature radius of the object-side surface of the first lens element in a maximum image height direction is R1, a focal length of the optical photographing lens assembly in the maximum image height direction is f, and the following condition is satisfied:
−4.5<R1/f<−0.30.

2. The optical photographing lens assembly of claim 1, wherein the paraxial curvature radius of the object-side surface of the first lens element in the maximum image height direction is R1, the focal length of the optical photographing lens assembly in the maximum image height direction is f, and the following condition is satisfied:
−3.5<R1/f<−0.70.

3. The optical photographing lens assembly of claim 1, wherein an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the i-th lens element is Vi, a refractive index of the first lens element is N1, a refractive index of the second lens element is N2, a refractive index of the third lens element is N3, a refractive index of the fourth lens element is N4, a refractive index of the fifth lens element is N5, a refractive index of the i-th lens element is Ni, a minimum value of Vi/Ni is (Vi/Ni)min, and the following condition is satisfied:
7.50<(Vi/Ni)min<11.0, wherein i=1,2,3,4 or 5.

4. The optical photographing lens assembly of claim 1, wherein a central thickness of the first lens element is CT1, a central thickness of the second lens element is CT2, a central thickness of the third lens element is CT3, a central thickness of the fourth lens element is CT4, a central thickness of the fifth lens element is CT5, and the following condition is satisfied:
2.0<(CT2+CT3+CT4+CT5)/CT1<6.5.

5. The optical photographing lens assembly of claim 1, wherein the fifth lens element has negative refractive power, the image-side surface of the fifth lens element is concave in a paraxial region thereof, and the image-side surface of the fifth lens element has at least one critical point in an off-axis region thereof and in the maximum image height direction.

6. The optical photographing lens assembly of claim 1, wherein the at least one freeform lens element has an optically non-effective area and comprises at least one positioning structure at the optically non-effective area;
wherein a maximum distance between an optical axis and a boundary of an optically effective area of the object-side surface of the first lens element is Y11, a maximum distance between the optical axis and a boundary of an optically effective area of the image-side surface of the fifth lens element is Y52, and the following condition is satisfied:
1.0<Y52/Y11<1.7.

7. An optical photographing lens assembly comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the object-side surface of the first lens element is concave in a paraxial region thereof, the five lens elements comprise at least one freeform lens element, and at least one of the object-side surface and the image-side surface of the at least one freeform lens element is a freeform surface;
wherein a focal length of the optical photographing lens assembly in a maximum image height direction is f, a composite focal length of the fourth lens element and the fifth lens element in the maximum image height direction is f45, and the following condition is satisfied:
1.9<f45/f.

8. The optical photographing lens assembly of claim 7, wherein the focal length of the optical photographing lens assembly in the maximum image height direction is f, the composite focal length of the fourth lens element and the fifth lens element in the maximum image height direction is f45, a central thickness of the first lens element is CT1, a central thickness of the second lens element is CT2, a central thickness of the third lens element is CT3, a central thickness of the fourth lens element is CT4, a central thickness of the fifth lens element is CT5, and the following conditions are satisfied:
2.3<f45/f<3.6; and
2.9<(CT1+CT2+CT4)/(CT3+CT5)<6.0.

9. The optical photographing lens assembly of claim 7, wherein an Abbe number of the third lens element is V3, an Abbe number of the fifth lens element is V5, and the following condition is satisfied:
20.0<V3+V5<60.0.

10. The optical photographing lens assembly of claim 7, wherein a paraxial curvature radius of the image-side surface of the fourth lens element in the maximum image height direction is R8, the focal length of the optical photographing lens assembly in the maximum image height direction is f, a composite focal length of the first lens element, the second lens element and the third lens element in the maximum image height direction is f123, and the following conditions are satisfied:
−2.3<R8/f<−0.43; and
1.0<f123/f<2.4.

11. The optical photographing lens assembly of claim 7, wherein the first lens element has negative refractive power, the object-side surface of the first lens element has at least one critical point in an off-axis region thereof and in the maximum image height direction;
wherein an axial distance between the object-side surface of the first lens element and an image surface is TL, the focal length of the optical photographing lens assembly in the maximum image height direction is f, an f-number of the optical photographing lens assembly is Fno, and the following conditions are satisfied:
2.2<TL/f<4.0; and
1.6<Fno<2.6.

12. The optical photographing lens assembly of claim 7, wherein a minimum value among distances between an optical axis and a boundary of an optically effective area of one lens surface is Ymin, a maximum value among displacements in parallel with the optical axis from an intersection point between the lens surface and the optical axis to positions at a distance of Ymin from the optical axis on the lens surface is SAG_MAX, a minimum value among displacements in parallel with the optical axis from the intersection point between the lens surface and the optical axis to positions at a distance of Ymin from the optical axis on the lens surface is SAG_MIN, an absolute difference between SAG_MAX and SAG_MIN is |dSAG|max, and the at least one freeform lens element has at least one freeform surface satisfying the following condition:
0.45 um<|dSAG|max.

13. An optical photographing lens assembly comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the first lens element has negative refractive power, the second lens element has positive refractive power, the image-side surface of the fifth lens element is concave in a paraxial region thereof, the five lens elements comprise at least one freeform lens element, and at least one of the object-side surface and the image-side surface of the at least one freeform lens element is a freeform surface;
wherein a central thickness of the first lens element is CT1, a central thickness of the fourth lens element is CT4, and the following condition is satisfied:
0.38<CT1/CT4<1.9.

14. The optical photographing lens assembly of claim 13, wherein the central thickness of the first lens element is CT1, the central thickness of the fourth lens element is CT4, and the following condition is satisfied:
0.50<CT1/CT4<1.3.

15. The optical photographing lens assembly of claim 13, wherein an Abbe number of the second lens element is V2, an Abbe number of the third lens element is V3, an Abbe number of the fourth lens element is V4, and the following condition is satisfied:
4.0<(V2+V4)/V3<8.5.

16. The optical photographing lens assembly of claim 13, wherein an axial distance between the second lens element and the third lens element is T23, an axial distance between the third lens element and the fourth lens element is T34, and the following condition is satisfied:
1.0<T34/T23<6.5.

17. The optical photographing lens assembly of claim 13, wherein an axial distance between the object-side surface of the first lens element and an image surface is TL, a maximum image height of the optical photographing lens assembly is ImgH, half of a maximum field of view of the optical photographing lens assembly is HFOV, and the following conditions are satisfied:
1.0<TL/ImgH<2.8; and
47.5 degrees<HFOV<70.0 degrees.

18. The optical photographing lens assembly of claim 13, wherein the object-side surface of the first lens element is concave in a paraxial region thereof;
wherein a paraxial curvature radius of the object-side surface of the first lens element in a maximum image height direction is R1, a focal length of the first lens element in the maximum image height direction is f1, and the following condition is satisfied:
0.10<R1/f1<1.9.

19. The optical photographing lens assembly of claim 13, wherein the object-side surface of the second lens element is convex in a paraxial region thereof, the image-side surface of the second lens element is convex in a paraxial region thereof, and the image-side surface of the third lens element is concave in a paraxial region thereof.

20. The optical photographing lens assembly of claim 13, wherein the fourth lens element has positive refractive power, the image-side surface of the fourth lens element is convex in a paraxial region thereof;
wherein a focal length of the fourth lens element in a maximum image height direction is f4, the central thickness of the fourth lens element is CT4, and the following condition is satisfied:
1.9<f4/CT4<5.0.

21. The optical photographing lens assembly of claim 13, wherein the fifth lens element has negative refractive power, the object-side surface of the fifth lens element is convex in a paraxial region thereof, and the object-side surface of the fifth lens element has at least one critical point in an off-axis region thereof and in a maximum image height direction;
wherein a paraxial curvature radius of the object-side surface of the fifth lens element in the maximum image height direction is R9, a paraxial curvature radius of the image-side surface of the fifth lens element in the maximum image height direction is R10, a focal length of the optical photographing lens assembly in the maximum image height direction is f, a focal length of the fifth lens element in the maximum image height direction is f5, and the following conditions are satisfied:
1.6<(R9+R10)/(R9−R10)<5.0; and
−1.0<f/f5<−0.20.

22. The optical photographing lens assembly of claim 13, wherein a minimum value among distances between an optical axis and a boundary of an optically effective area of one lens surface is Ymin, a maximum value among displacements in parallel with the optical axis from an intersection point between the lens surface and the optical axis to positions at a distance of Ymin from the optical axis on the lens surface is SAG_MAX, a minimum value among displacements in parallel with the optical axis from the intersection point between the lens surface and the optical axis to positions at a distance of Ymin from the optical axis on the lens surface is SAG_MIN, an absolute difference between SAG_MAX and SAG_MIN is |dSAG|max, a central thickness of the at least one freeform lens element is CTF, and the at least one freeform lens element has at least one freeform surface satisfying the following condition:
1.00E-3<|dSAG|max/CTF.

23. An image capturing unit, comprising:
the optical photographing lens assembly of claim 13; and
an image sensor disposed on an image surface of the optical photographing lens assembly.

24. An electronic device, comprising:
the image capturing unit of claim 23.
